(19) United States
(12) Patent Application Publication
(10) Pub. No.: US 2026/0220391 A1
(43) Pub. Date: Jul. 30, 2026

(54) Summarizing LLM Predictive Distributions from Embeddings

(71) Applicant: GDM Holding LLC, Mountain View, CA (US)

(72) Inventors: Roland Jasper Snoek, Cambridge, MA (US); Alexander Nicholas D'Amour, Arlington, MA (US); Jenny Hamer, New York, NY (US); Victor Carlyle Veitch, Chicago, IL (US); Jie Ren, San Jose, CA (US); Dheeraj Rajagopal, Seattle, WA (US); Kevin Alan Robinson, Stoneham, MA (US)

(21) Appl. No.: 19/465,889

(22) Filed: Jan. 30, 2026

Related U.S. Application Data
(60) Provisional application No. 63/751,808, filed on Jan. 30, 2025.

(51) Int. Cl. G06F 40/40; G06F 40/284

(52) U.S. Cl. CPC G06F 40/40; G06F 40/284

(57) ABSTRACT

A computer-implemented method of determining an estimate of uncertainty associated with a plurality of candidate output token sequences generated using a trained generative neural network is provided. The method comprises obtaining i) an input token sequence, ii) using the generative neural network to process the input token sequence to generate the plurality of candidate output token sequences for the input token sequence, the processing comprising, for each candidate output token sequence, using the generative neural network to generate a respective embedding vector associated with the candidate output token sequence, iii) processing each embedding vector, using an embedding model, to generate a respective lower-dimensional embedding of the embedding vector, iv) determining a respective distance value for each pair of lower-dimensional embeddings in the plurality of lower-dimensional embeddings, and v) determining the estimate of uncertainty associated with the plurality of candidate output token sequences based on the plurality of distance values.

### CROSS-REFERENCE TO RELATED APPLICATION

This application claims priority under 35 U.S.C. 119 to Provisional Application No. 63/751,808, filed Jan. 30, 2025, which is incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

A generative neural network (e.g. a large language models (LLM) or a vision-language models VLM) processes an input token sequence representing input query to generate an output, comprising an output sequence of tokens which may represent a piece of text for example which is a sensible response to the input query, e.g. an answer to a question posed by the input query. There are many applications for which it is important that the user (e.g. a human user or a software application/agent) of the generative neural network is provided with an effective indicator of whether the model knows the correct answer to a prompt or is confabulating (e.g. “hallucinating”) in its response.

This specification describes systems and methods implemented as computer programs on one or more computers in one or more locations that enable estimating the degree of (un) certainty associated with responses of a generative neural network generated in response to an input query. In broad terms, the proposed techniques involve sampling multiple responses for the same input query and using a trained model (“embedding model”) to map latent space representations of these responses to a subspace of the latent space that encodes “semantic” distances between the responses. The relative positions of the responses within this subspace can then be analyzed (e.g. via cluster analysis and the like, as described below in more detail) to yield a fine-grained measure of uncertainty associated with the responses. This specification also describes the training of the embedding model.

According to a first aspect, there is provided a computer-implemented method of determining an estimate of uncertainty associated with a plurality of candidate output token sequences generated using a trained generative neural network (e.g. a transformer-based generative neural network). The method comprises obtaining an input token sequence and using the generative neural network to process the input token sequence to generate the plurality of candidate output token sequences for the input token sequence (i.e. multiple responses are sampled from the generative neural network for the same input token sequence). The plurality of candidate output token sequences may be generated independently of each other (e.g. one after the other or in parallel by different instances of the generative neural network, as described below in more detail). The input token sequence (e.g. a sequence of tokens selected from an input token vocabulary) may be obtained from a user (e.g. via a user interface) or from another software application (e.g. a software agent). The input token sequence may represent a query for example. The input token sequence may comprise “text tokens” from a vocabulary (e.g. tokens representing letters selected from an alphabet (e.g. a natural language alphabet) and/or words or parts of words), “image tokens” (e.g. data representing images or patches of images), and/or “audio tokens” (e.g. data representing sounds, e.g. speech). In particular, the input sequence may represent an interleaved sequence of any one or more of text, image (or video in form of a sequence of images), and/or audio.

Similarly, each output token sequence may comprise a sequence of tokens which may, but need not be, selected from an output token vocabulary (which can be different to the input token vocabulary). The output token sequences may comprise any one or more of text, image and/or audio tokens. In general, each output sequence may represent text, images, audio (sound signals), and/or videos which are a response to the input query (for example, such as an answer to a question posed by the input query). The plurality of output token sequences may be different, i.e. the different output token sequences may differ syntactically (i.e. they may differ in structure, length, or other syntactic elements) and/or differ semantically (i.e. they may have different meanings).

The generative neural network may be implemented using known neural network architectures. More specifically, in some implementations, the generative neural network may be a trained language neural network or a trained vision language model (as further described below). Thus, the generative neural network may be a “multimodal” model which is trained not only across text but also across still images, audio (sound signals), and/or videos. That is, either or both of the output or input of the generative neural network can include a media element comprising still image(s), audio, and/or video(s), in addition to the text tokens. The generative neural network may also be capable of processing an input which comprises a media element but not text tokens.

Processing of the input token sequence comprises using the generative neural network to generate, for each candidate output token sequence, a respective embedding vector associated with the candidate output token sequence. Thus, each embedding vector, denoted xᵢ (with i=0, . . . , m−1, where m denotes the number of generated candidate output token sequences), encodes a corresponding candidate output token sequence.

Many possibilities exist to generate the embedding vector. In some implementations, the generative neural network may generate, for each candidate output token sequence, a respective score vector (comprising a plurality of scores, e.g. indicative of a score distribution over the vocabulary of output tokens) for each position in the candidate output token sequence based on the input token sequence and based on any previously selected tokens in the candidate output token sequence. The respective embedding vector for a candidate output token sequence may be generated based on the generated score vectors, e.g. by averaging (e.g. elementwise averaging) the respective score vectors across the positions in said candidate output token sequence. In some implementations, the generative neural network comprises a plurality of hidden layers and the embedding vectors are generated based on the output of one of the hidden layers. For example, the score vectors can be obtained based on the output of one of the hidden layers, e.g. the output of the hidden layer may directly form the score vector (score vectors obtained from hidden layers are sometime referred to as “representation vectors” or “activation vectors”). In some implementations, the generative neural network further comprises a “logit layer” which generates a final score/logit distribution over the vocabulary of output tokens (i.e. a score/logit value for each token in vocabulary of output tokens) and the generative neural network implements a softmax function (or the like) which is applied to this logit distribution to obtain a next-token probability distribution. In these cases, the score vectors (and thus the embedding vectors) may be obtained from the output of the last hidden layer, i.e. the layer immediately preceding the logit layer. The last hidden layer may be the penultimate layer of the generative neural network. In other implementations, the score vectors (and thus the embedding vectors) may be obtained from the output of a different layer, e.g. a different hidden layer or from the output of the logit layer (i.e. from the logit distribution).

The method further comprises a step of processing each embedding vector, using an embedding model, to generate a respective lower-dimensional embedding of the embedding vector. The embedding model is a trained model (e.g. a trained neural network) configured to receive, as model input, an embedding vector, and to generate, as output, a corresponding lower-dimensional embedding. A “lower-dimensional embedding” may be a vector (or some other ordered array of a plurality of numerical values) that comprises fewer elements than the corresponding embedding vector. In some implementations, the embedding model may be a neural network consisting of an input layer, a single hidden layer and an output layer. The embedding model may be trained so that the latent subspace into which the embedding model projects the embedding vectors encodes semantic distances between the embedding vectors, as described below in more detail.

The method further comprises determining a respective distance value for each pair of lower-dimensional embeddings in the plurality of lower-dimensional embeddings. The distance values may be determined using a trained distance model configured to generate a distance value for a pair of input low-dimensional embeddings.

The method further comprises a step of determining the estimate of uncertainty associated with the plurality of candidate output token sequences based on the plurality of the distance values. Many possibilities exist to determine the estimate of uncertainty associated with the plurality of candidate output token sequences based on the plurality of distance values. In one possibility, the estimate of uncertainty may be determined based on an estimate of the volume spanned by the lower-dimensional embeddings in the latent subspace (i.e. in the associated embedding space). In general, a larger spanned volume indicates that the semantic similarity between the candidate responses is lower compared to a smaller spanned volume, and thus that the generative neural network is less certain about its answer. The spanned volume can be computed or approximated based on the plurality of distance values.

In some implementations, determining the estimate of the volume spanned by the lower-dimensional embeddings may comprise generating, from the plurality of distance values, a matrix input for a determinant function, determining an output of the determinant function, and determining the estimate of the volume spanned by the lower-dimensional embeddings from the output of the determinant function. More specifically, a covariance matrix, denoted L, may be constructed from the plurality of distance values, and the estimate of the volume spanned by the lower-dimensional embeddings may be determined as the logarithm of the determinant of the matrix L (L+1)⁻¹ where L represents a covariance matrix derived from semantic distances in the latent subspace and/represents an identity matrix of corresponding dimensions.

In another possibility, the estimate of uncertainty may be determined by performing a cluster analysis of the lower-dimensional embeddings. More specifically, in some implementations, determining the estimate of uncertainty may comprise obtaining clustering data by assigning, based on the determined distance values, each lower-dimensional embedding to one of a plurality of clusters, and determining the estimate of uncertainty based on the clustering data. For example, the estimate of uncertainty can be determined based on the number of lower-dimensional embeddings assigned to each cluster.

In some implementations, obtaining clustering data may comprise determining, based on the determined distance values, the number of clusters in the plurality of lower-dimensional embeddings, selecting, for each cluster, one of the lower-dimensional embeddings as respective cluster centre for the cluster based on the determined distance values and assigning, for each of the remaining lower-dimensional embeddings, the remaining lower-dimensional embedding to one of the clusters based on the determined distance values between the remaining lower-dimensional embedding and the cluster centers. The number of clusters in the plurality of lower-dimensional embeddings may be determined based on the trace of a matrix formed based on the distance values, e.g. based on the trace of the matrix (L(L+I)⁻¹).

In some implementations, the cluster centers are iteratively selected. Each iteration may comprise i) determining, for each remaining lower-dimensional embedding, a determinant value of a matrix formed based on the distance values for the remaining lower-dimensional embedding and the cluster centers selected in the previous iterations and ii) selecting, as cluster centers for the current iteration, one of the remaining lower-dimensional embeddings based on the determined determinant values.

In some implementations, the method may further comprise outputting of the estimate of uncertainty to the user or the software agent that provided the input token sequence. This allows the user/agent to make an informed decision whether it is safe to use/rely on the output of generative neural network.

In some implementations, the method may further comprise steps of selecting one of the candidate output token sequences based on the determined distance values and outputting, as the response to the input token sequence, the selected candidate output token sequence. As one example, the candidate output token sequence that is associated with the largest eigenvector of a matrix formed based on the distance values (e.g. matrix (L(L+I)⁻¹) may be selected as response to input token sequence. Alternatively, the clustering data may be used to select the output token sequence. More specifically, the method may comprise determining, from the plurality of clusters, the cluster that comprises the largest number of lower-dimensional embeddings and selecting (e.g. randomly) one of the candidate output token sequences associated with the cluster that comprises the largest number of lower-dimensional embeddings. In some implementations, a (randomly selected) candidate output token sequence from each cluster may be output together with a corresponding estimate of uncertainty associated with that cluster.

The system may implement a selective prediction protocol wherein the system abstains from answering a query if the determined estimate of uncertainty exceeds a threshold. Thus, in some implementations, the method may further comprise determining whether the estimate of uncertainty exceeds a threshold criterion and in response to determining that the estimate of uncertainty exceeds a threshold criterion, refraining from outputting one of the candidate output token sequences as the response to the input token sequence.

In other implementations, when the estimate of uncertainty exceeds a threshold criterion, the input token sequence may be input into a second generative neural network which is more capable than the first-mentioned generative neural network (e.g. the second generative neural network may have a larger number of learnable parameters than the first-mentioned generative neural network, e.g. at least 10 times more learnable parameters). In this case, the second generative neural network may generate an output token sequence which is output to the user/agent as response to the input query. The output of the second generative neural network is more likely to be correct because the second generative neural network is more capable. This enables efficient use of computing resources since the larger model is only called when needed.

In other implementations, the method may further comprise, in response to determining that the estimate of uncertainty exceeds a threshold criterion, obtaining a further input token sequence (e.g. representing additional information gathered from the user or by calling an external software tool) and processing the initial input token sequence and the further input token sequence to generate a further candidate output token sequence which is then output as the response to the input token sequence.

In addition or alternatively, the generative neural network may be in communication with at least one software agent and the method may further comprise determining whether the estimate of uncertainty exceeds a threshold criterion, and in response to determining that the estimate of uncertainty exceeds a threshold criterion, transmitting a query to the agent. In response to the query, the agent may transmit response data for the transmitted query. When the response data item is received, the generative neural network processes the input token sequence and the response data item to generate a further candidate output token sequence which is output as the response to the input token sequence.

In some implementation, the method may be performed by a parallel or distributed processing system comprising a plurality of processing units each implementing a respective instance of the generative neural network. The method may further comprise distributing the input token sequence to each of the plurality of processing units and using the plurality of processing units in parallel, to process the input token sequence to generate the plurality of candidate output token sequences and the associated embedding vectors in parallel. Since the candidate output token sequences (and the associated embedding vectors) are generated independently from each other, the generation of the candidate output token sequences and the associated embedding vectors can be carried out on parallel and distributed processing systems more easily without requiring any special data or resource allocation considerations. Thus, the method is particularly adapted for parallel and distributed processing systems and accelerator hardware.

In some implementations, the generative neural network is implemented on a parallel or distributed processing system comprising a plurality of processing units and is configured to process a batch of input tokens in parallel. In these cases, using the generative neural network to process the input token sequence may comprise generating a batch of input tokens comprising repeated copies of part or all of the input token sequence (one copy per candidate output token sequence) and processing the batch of input tokens in parallel, using the plurality of processing units, to generate the plurality of candidate output token sequences and the associated embedding vectors, comprising processing the batch of input tokens using the generative neural network to generate, in parallel, an output token for each candidate output token sequence. In these implementations, the system may further comprise one or more tensor processing units or one or more graphics processing units (or another type of neural network accelerator hardware) to implement the above-described parallel processing.

According to another aspect, there is provided a computer-implemented method of training the embedding model to generate a lower-dimensional embedding from an input comprising an embedding vector. The training method comprises obtaining a dataset of training examples. Each training example comprises i) a plurality of training embedding vectors, each embedding vector associated with a corresponding training output token sequence, and ii), for each training embedding vector, a label indicating one of a plurality of clusters. The training output token sequences have been generated by the above-described generative neural network for the same training input token sequence.

The method further comprises processing each training embedding vector, using the embedding model, to generate a respective lower-dimensional embedding and determining a respective distance value for each pair of lower-dimensional embeddings associated with the same training example in the plurality of lower-dimensional embeddings. Then a plurality of training steps are performed. In each training step, for each training sample, a (single) lower-dimensional embedding is sampled for each cluster in the plurality of clusters associated with the training example. A loss function is then evaluated based on the distance values associated with the sampled associated lower-dimensional embeddings and the trainable parameters of the embedding model based are updated based on the evaluated loss function. In some implementations, the parameter(s) of the above-described distance model are jointly trained with the embedding model.

In some implementations, the loss function may be a “contrastive” loss function comprising a first term that depends on the distance values associated with the sampled lower-dimensional embeddings, and a second term that depends on the distance values associated with the sampled lower-dimensional embeddings and on the distance values associated with the remaining lower-dimensional embeddings. The first term encourages larger distance values for the sampled lower-dimensional embeddings, and the second term encourages smaller distance values for the sampled lower-dimensional embeddings and the remaining lower-dimensional embeddings. The loss function may be given by or comprise log P_{L}( [symbol] )=log det( [symbol] )−log det(L+I), where L is the covariance matrix over the full set [symbol] of training responses for the same input query (i.e. the lower-dimensional embeddings belonging to the same training example) constructed using the distance values, [symbol] is the submatrix corresponding to the subset [symbol] of the lower-dimensional embeddings that have been sampled in this iteration, and I is the identity matrix.

To generate the labels of the training dataset, a further generative neural network model may be used. More specifically, the training method may further comprise an initial step of generating, for each training embedding vector, the respective label indicating one of a plurality of clusters by processing the corresponding training output token sequences, using the further generative neural network, to perform pairwise bi-directional entailment to identify training output token sequences that are semantically consistent, and generating, for each training embedding vector, the respective label indicating one of a plurality of clusters so that training output token sequences that are semantically consistent are associated with the same cluster.

According to another aspect, there is provided a system that includes one or more computers and one or more storage devices communicatively coupled to the one or more computers and storing instructions that, when executed by the one or more computers, cause the one or more computers to perform operations of the previously described method.

According to another aspect, there is provided one or more non-transitory computer storage media storing instructions that when executed by one or more computers cause the one or more computers to perform operations of the previously described method.

Particular embodiments of the subject matter described in this specification can be implemented so as to realize one or more of the following advantages.

Implementations of the described techniques enable quantifying a model's uncertainty in way that is more efficient in time and compute compared to other methods (e.g. compared to methods that require O(m²) model calls to compare and cluster “m” sequences). As confirmed experimentally in language model examples (Gemma 9b), implementations of the described techniques achieve a hallucination detection performance that is better than computationally more expensive methods.

As described below in more detail, in some implementations, the described techniques leverage determinantal point processes (DPPs) to learn a distance metric that captures semantic similarity, enabling efficient clustering and selective prediction. It is advantageous that the described techniques enable learning semantically distinct clusters of the data in a fully unsupervised manner. It is also advantageous that the described techniques enable the estimation of a respective uncertainty for each semantic cluster because this information can be useful in downstream decisions that are based on the model's output.

Further, the described techniques are particularly suitable for implementations using parallel and distributed computing. In particular, the generation of the candidate output token sequences and the associated embedding vectors can be carried out on parallel and distributed processing systems because there are no dependencies between the candidate output token sequences (and the associated embedding vectors) within the plurality of candidate output token sequences. It is also advantageous that the system described in this specification can be combined with trained generative neural networks (e.g. Large Language Models), i.e. the described techniques can be implemented without requiring re-training these models which is time and resource intensive.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example computer system that processes an input token sequence.

FIG. 2 is a flow diagram of an example process of processing an input token sequence.

FIG. 3 shows an example computer system for training an embedding model.

FIG. 4 is a flow diagram of an example process of training an embedding model.

FIG. 5 illustrates experimental results from example implementations of the computer systems of FIG. 1.

Like reference numbers and designations in the various drawings indicate like elements.

### DETAILED DESCRIPTION

Generative neural networks, such as Large Language Model neural networks (LLMs), are neural networks which process an input query, comprising a sequence of tokens and/or other data such as a media element, to generate an output, comprising an output sequence of tokens typically representing a piece of text which is a sensible response to the input query, e.g. an answer to a question posed by the input query. The output token sequences are generated by sampling from a distribution over token sequences conditioned on the input query. Thus, a generative neural network defines internally a complex, high-dimensional distribution over possible responses to an input query, rather than a single deterministic output. This distribution encodes the model's uncertainty with respect to the input query, but its complexity and high dimensionality hinder practical utilization. That is, it is challenging to analyse this distribution to extract valuable information about the model's uncertainty. For example, simple summaries, like individual token probabilities, tend to capture superficial variations (syntax, synonyms) rather than meaningful semantic differences. Exhaustive enumeration of all possible responses is often intractable. It is therefore desirable to provide new techniques for summarizing the posterior distribution over token sequences. As described below in detail, the posterior distribution over token sequences can be efficiently summarized as a small set of semantically distinct responses.

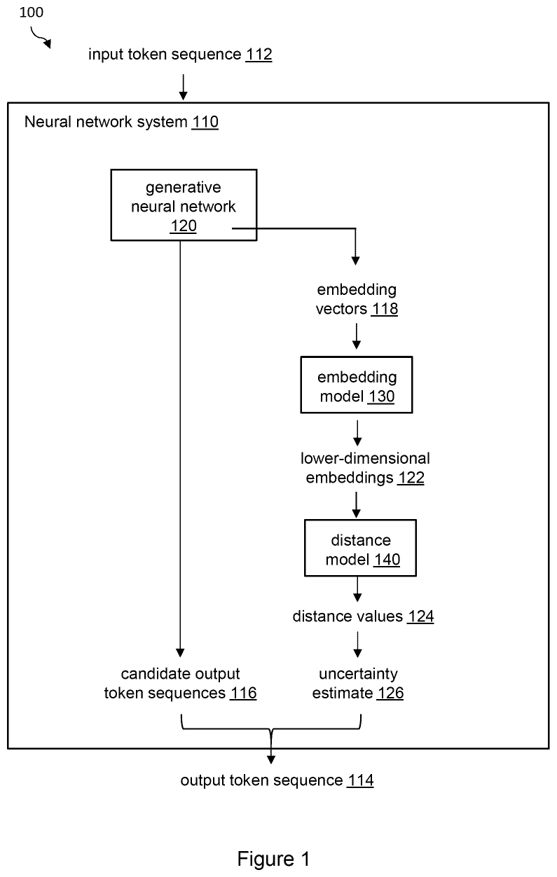

FIG. 1 shows an example computer system 100. The computer system 100 is an example of a system, implemented as computer programs on one or more computers in one or more locations, in which the systems, components, and techniques described below are implemented. In broad terms, the computer system 100 estimates the semantic variation in outputs of a generative neural network based on internal model activations and uses this to quantify model uncertainty. The so-obtained measure of uncertainty is an effective indicator of whether the model knows the correct answer to an input query or is confabulating (e.g. “hallucinating”, i.e. didn't know the right output and gave a wrong answer) in its response.

More specifically, the computer system 100 comprises a neural network system 110 configured to process an input query 112 to generate an output token sequence 114. The input query 112 defines a query or task for the neural network system 110, and may be obtained from a user (e.g. via user interface), from another software application (such as a software agent), or the like. The input query 112 can include one or more modalities including text, image, audio, video, or a combination of one or more such modalities. In general, the network input can include multiple modalities depending on the specific architecture of the neural network system. The output token sequence 114, represents a response to the input query 112 and comprises a sequence of tokens selected from an output token vocabulary (which can be different to the input token vocabulary). Similar to the input token sequence 112, the output token sequence 114 may comprise text, image and/or audio tokens.

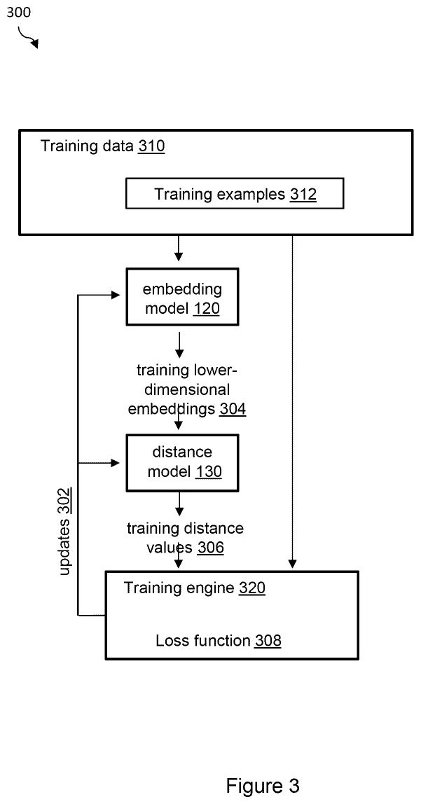

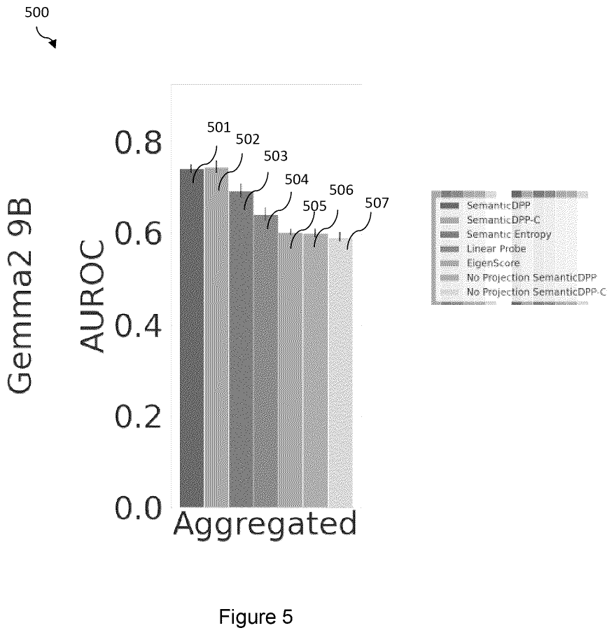

The neural network system 110 comprises a trained generative neural network 120, a trained embedding model 130, and a trained distance model 140. The generative neural network 120 has a plurality of learnable/tunable numerical parameters (e.g. at least 1000, at least 100,000, or more numerical parameters). The generative neural network 120 may have been first pre-trained on a large, unlabeled (text) dataset (e.g. Web data) and then fine-tuned for one or more downstream tasks. The pre-training may be performed by self-supervised learning (also known as predictive learning) in which the generative neural network 120 learns to correctly predict continuations of received samples of a text database, such as a large, publicly available database of natural language. The pre-trained generative neural network may have been further trained (“fine-tuned”) which may involve supervised training on smaller, more carefully curated datasets (e.g. containing expert demonstrations of high-quality responses) and/or human-annotated preference datasets. The models 130, 140 have been trained (i.e. the numerical values of the respective parameters have been adjusted) based on training data as described further below with reference to FIGS. 3 and 5.

In general, the generative neural network 120 may be implemented using known generative neural network architectures. For example, the generative neural network 120 may comprise a transformer network, i.e. a neural network subsystem including one or more transformer blocks or self-attention layers. A transformer block typically includes an attention or self-attention neural network layer followed by a feedforward neural network. An attention, or self-attention, neural network layer is a neural network layer that includes an attention or self-attention mechanism that operates over an attention layer input to generate an attention layer output. More specifically, the generative neural network 120 may comprise a respective transformer neural network with an architecture similar to the transformer neural network described in Vaswani et al, Advances in neural information processing systems, 30, 2017. For example, the generative neural network 120 may comprise an architecture similar to a (standard) vision transformer neural network (e.g. similar to the Vision Transformer (ViT) described in Dosovitskiy et al, arXiv: 2010.11929). Thus, in some implementations, the generative neural network 120 is a vision language model which can process visual (image and video) data along with text data as the input query.

The generative neural network 120 is configured to process the input token sequence of the input query 112 to generate a “candidate output token sequence” for the input token sequence. As described below in more detail, when the neural network system 110 is being used to generate the output token sequence 114, the generative neural network 120 generates a plurality of candidate output token sequences 116 (i.e. multiple responses are sampled from the generative neural network 120 for the same input token sequence; the number of generated candidate output token sequences 116 is denoted by the symbol ‘m’ hereafter). The plurality of candidate output token sequences 116 may be generated independently of each other (e.g. one after the other).

In general, the plurality of output token sequences 116 may be different, i.e. the output of the generative neural network 120 is not deterministic, and thus the generative neural network 120 may generate different output token sequences when prompted multiple times with the same input token sequence. The different output token sequences 116 may differ syntactically (i.e. they may differ in structure, length, or other syntactic elements) and/or differ semantically (i.e. they may have different meanings). Two sequences/pieces of text (or other media elements) can be considered to be semantically similar if they convey the same meaning (irrespective of their structure, length, or other syntactic elements). Thus, for the purposes of this disclosure, two candidate output token sequences are defined as semantically similar if they are semantically consistent, such as when they convey a substantially equivalent meaning or result in an identical downstream decision, regardless of syntactic or structural variations. Accordingly, the term “semantic similarity” is used to capture the degree of resemblance of meaning between the texts (or other media elements). The variability in semantic meaning of sampled model responses to the same input query is a strong indicator of (non) reliability of a generated response. Thus, as described below in more detail, to estimate how certain the generative neural network 120 is that its responses are correct, the neural network system 110 captures the semantic similarity of the plurality of output token sequences 116 while ignoring syntactic variability. As described below in more detail, the neural network system 110 obtains a measure of this semantic similarity from internal activations of the generative neural network 120, i.e. from internal activations of the model that is generating the responses, rather than by processing the output token sequences 116 themselves. In other words, the uncertainty quantification is derived directly from internal model activations (e.g., hidden layer outputs or logits) of the generative neural network, providing a computationally efficient signal that bypasses the need for secondary model-based (textual) analysis of the generated sequences.

More specifically, the neural network system 110 is further configured to generate an associated embedding vector 124 for each candidate output token sequence 116. The embedding vectors 124 are generated such that each embedding vector encodes a corresponding candidate output token sequence (e.g. the sematic meaning of the corresponding candidate output token sequence). The embedding vectors may be d-dimensional vectors denoted with the symbol x (x∈ [symbol] ^{d}), i.e. xᵢ is a vector space representation of the i-th candidate output token sequence may be a d-dimensional vector (with i=0, . . . , m−1, where m denotes the number of generated candidate output token sequences 116 as noted above).

Many possibilities exist to generate the embedding vectors 118. In the example of FIG. 1, the generative neural network 120 comprises a plurality of hidden layers and the embedding vectors 118 are generated based on the output of one of the hidden layers. That is, the embedding vectors 118 are generated based on internal model activations rather than, for example, a next-token probability distribution. More specifically, in this example, in order to generate one of the candidate output token sequences 116, the generative neural network 120 is configured to process the input token sequence to autoregressively generate, for each position in the respective candidate output token sequence, a respective score distribution over the vocabulary of output tokens, i.e. a respective score (logit) for each token in a vocabulary of output tokens. The score may be indicative of a predicted likelihood that the corresponding token is the most suited token for the next position in the output token sequence. A softmax function (or the like) may then be applied to these scores to obtain the next-token probability distribution. The layer of the generative neural network that generates the final score/logit distribution is referred to as “logit layer”. The hidden layers preceding the logit layer are configured to process the input token sequence to autoregressively generate, for each position in the respective candidate output token sequence, a respective score vector comprising a plurality of score values. In the example of FIG. 1, the embedding vectors 118 are generated based on the score vectors generated by the last hidden layer, i.e. the layer immediately preceding the logit layer. In other implementations, the embedding vectors may be generated based on score vectors generated by a different hidden layer or based on the logits generated by the logit layer (e.g. before a softmax function is applied to obtain the next-token probability distribution). Generating the embedding vectors based on the output of the last hidden layer rather than based on the logits generated by the logit layer can be advantageous because the logit layer is often much larger (in some cases, 256 k vs 5012 units) and semantically sparse compared to the last hidden layer.

More specifically, the embedding vector xᵢ may be generated from the respective score vectors generated for the i-the candidate output token response by the last hidden layer of generative neural network. In the example of FIG. 1, the embedding vector xᵢ is generated by (elementwise) averaging the respective score vectors across the positions in the i-th candidate output token sequence. Generating the embedding vector xᵢ may further involve performing a whitening transformation on the (averaged) scores (e.g. a whitening transformation that is equivalent to a causal inner product). In other implementations, the embedding vector xᵢ may be generated from the corresponding score vectors in a different way (e.g. by taking the median across the positions in the candidate output token sequence or by concatenating the score vectors).

The embedding model 130 is a trained model configured to receive, as model input, an embedding vector, and to generate, as output, a corresponding lower-dimensional embedding. More specifically, the embedding model 130 is configured to generate a plurality of lower-dimensional embeddings 122 corresponding to the plurality of embedding vectors 118. The plurality of lower-dimensional embeddings 122 is generated independently of each other (e.g. one after the other).

In general, a “lower-dimensional embedding” may be a vector (or some other ordered array of a plurality of numerical values) that comprises fewer elements than the corresponding embedding vector, i.e. the embedding model 130 maps an input embedding vector to a subspace of the embedding (or “latent”) space. More specifically, in the example of FIG. 1, the embedding model 130 is configured to implement a non-linear mapping function denoted φ(x): [symbol] ^{d}→ [symbol] ^{p} that maps a d-dimensional embedding vector x (associated with one of the output token sequences) to a p<d-dimensional subspace (e.g. φ(xᵢ) denotes the lower-dimensional embedding of the embedding vector xᵢ).

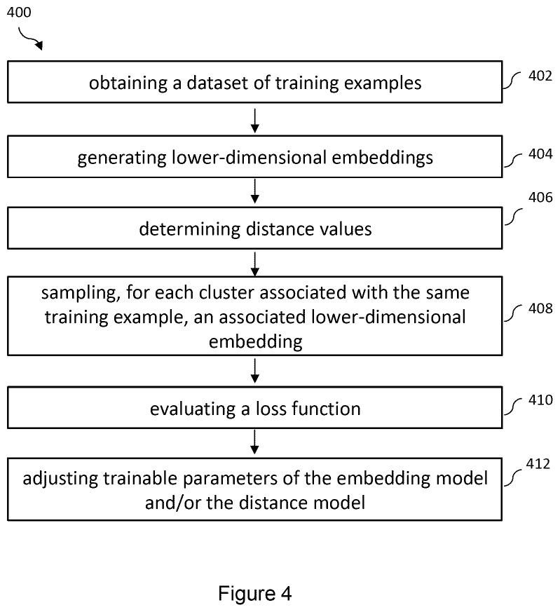

The training of the embedding model 130 is described in more detail below with reference to FIGS. 3 and 4. In broad terms, the embedding model 130 is trained so that the subspace (into which the embedding model projects the input embedding vector) encodes semantic similarity between the embedding vectors (i.e. between the corresponding output token sequences), i.e. the embedding model 130 is trained to project an input embedding vector into a semantically-meaningful vector space. That is, a degree of spatial proximity of two lower-dimensional embeddings in said embedding subspace indicates a corresponding degree of semantic similarity between the two associated output token sequences. It is to be understood that semantically similar responses normally lead to the same downstream decisions, thus may be considered to be equivalent.

In general, the embedding model 130 can be implemented using any model architecture that enables mapping of embedding vectors to corresponding lower-dimensional embeddings. In the example of FIG. 1, the embedding model 130 is a simple one-layer neural network, i.e. a trained neural network (trained as described below with reference to FIGS. 3 and 4) consisting of an input layer, a single hidden layer and an output layer. In other implementations, the embedding model may include more than one hidden layer.

The similarity between two embedding vectors, e.g. xᵢ and xⱼ, can be computed using the distance model 140. That is, the distance model 140 is a trained model configured to receive, as model input, a pair of low-dimensional embeddings, e.g. xᵢ and xⱼ, and to generate a corresponding distance value. More specifically, the distance model 140 is configured to generate a respective distance value 124 for each pair of lower-dimensional embeddings in the plurality of lower-dimensional embeddings 122. To this end, the distance model 140 implements a kernel or covariance function k(xᵢ, xⱼ) that depends on distances in the embedding subspace. In general, any suitable distance metric (e.g. Euclidean distance) may be used to determine the distances between pairs of lower-dimensional embeddings in the embedding subspace. In the example of FIG. 1, the distance model 140 may compute the distance value associated with the i-th and j-th candidate output trajectory as

$$k ( {x}_{i} , {x}_{j} ) = exp ( - α {‖ ϕ ( {x}_{i} ) - ϕ ( {x}_{j} ) ‖}^{2} ) \qquad Eq . ( 1 )$$

where |·| denotes a norm function and α is a parameter. In some implementations, the parameter α may be learnt (i.e. adjusted based on training data). For example, the parameter α may be jointly trained with the trainable parameters of the embedding model (i.e. the non-linear mapping function φ(x)). As described in detail below with reference to FIGS. 3 and 4, the training of the embedding model 130 and the distance model 140 uses determinantal point processes (DPPs) to learn a model over semantic (dis) similarity in the lower-dimensional embeddings.

In some embodiments, it is advantageous to compute the distance values based on the lower-dimensional embeddings φ(x) (as in Eq. (1)) rather than directly from the embedding vectors x. This is because a distance function that is linear in the embedding vectors x (such as the Mahalanobis distance function d(xᵢ, xⱼ)=\sqrt{(xᵢ−xⱼ)^{T}M⁻¹(xᵢ−xⱼ)}, where M is a positive semi-definite matrix providing a linear projection onto a lower dimensional subspace) may be insufficiently expressive to capture the complexity of relationships between datapoints.

The neural network system 110 is further configured to determine an estimate of uncertainty 126 associated with the plurality of candidate output token sequences 112 based on the plurality of distance values 124. Many possibilities exist to determine the estimate of uncertainty associated with the plurality of candidate output token sequences based on the plurality of distance values. Some implementations implement approaches that utilize determinantal point processes (DPPs). Before describing specific possibilities of how the neural network system 110 can determine the estimate of uncertainty 126, a high-level overview of the DPP formalism is provided.

In general, DPPs relate to probabilistic models which capture negative correlations between points and offer efficient methods for making various forms of inferences over the distribution they represent, including algorithms for sampling and computing marginal probabilities. Given a ground set of objects or data [symbol] , a point process [symbol] on [symbol] (denoted by [symbol] ) is a probability measure on the power set of [symbol] (i.e. [symbol] ). [symbol] is a determinantal point process if, for a subset [symbol] ⊆ [symbol] , the probability that [symbol] is contained in a random set [symbol] is P( [symbol] ⊆ [symbol] )=det [symbol] , where K∈ [symbol] ^{nxn} is a symmetric positive-semidefinite matrix indexed by the elements of [symbol] . The principal submatrix of K obtained by restricting rows and columns indexed in [symbol] is denoted

[symbol]

The assumptions on the matrix K are that its eigenvalues must lie between [0,1] and the marginal probability of any element eᵢ∈ [symbol] is given by Kᵢᵢ (the matrix K is often referred to as the marginal kernel because it encodes all the information needed to compute the probability of any subset S being included in [symbol] , i.e. P( [symbol] ⊆ [symbol] )). The marginal probability of including any two elements, e.g. eᵢ and eⱼ, is given by

$$P ( {e}_{i} , {e}_{j} ∈ 𝒴 ) = {K}_{ii} {K}_{jj} - {K}_{ij}^{2} = P ( {e}_{i} , ∈ 𝒴 ) P ( {e}_{j} ∈ 𝒴 ) - {K}_{ij}^{2} .$$

Intuitively, the larger the value of Kᵢⱼ, the more unlikely eᵢ and eⱼ are to appear together, which provides a simple model of repulsion between two elements. As such, DPPs model negative correlations between points which is a useful feature that is leveraged in some implementations of the proposed techniques.

A particularly useful class of DPPs is known as “L-ensembles” (Borodin & Rains, 2005). An L-ensemble is defined using a real, symmetric positive semi-definite matrix L indexed by the elements of [symbol] . Within an L-ensemble, the probability of a subset [symbol] ⊆ [symbol] is proportional to the det( [symbol] ) and is given by P_{L}( [symbol] )=det( [symbol] )/det(L+I) where L is the covariance matrix over the full set [symbol] , constructed using the above-described kernel k(xᵢ, xⱼ), [symbol] is the submatrix corresponding to the subset [symbol] , and I is the identity matrix.

While both general DPPs and L-ensembles allow computing marginal probabilities, L-ensembles allow directly calculating the probability of any selecting subset, including the empty set. As described below with reference to FIGS. 3 and 4, this formulation provides a tractable marginal likelihood which enables learning the parameters of the kernel (i.e. finding suitable values for the learnable parameters of the embedding model 120 and the distance model 130) by maximizing the probability of “ground truth” semantic clusters (the normalizing term det( [symbol] +I) efficiently computes the sum of the determinants over all possible subsets).

Referring back to FIG. 1, the neural network system 110 can determine the estimate of uncertainty 126 from the distance values 124 in different ways. In a first possibility, the neural network system 110 is configured to determine the estimate of 126 uncertainty based on an estimate of the volume spanned by the lower-dimensional embeddings φ(x) in the embedding subspace (i.e. in the semantically-meaningful vector space of the lower-dimensional embeddings φ(x)). The volume spanned by the sampled responses can be considered as being indicative of a “semantic” entropy associated with the sampled responses. In other words, the volume spanned by the sampled responses over the subspace represents the semantic diversity of the sampled responses and thus the uncertainty of the generative neural network 110 over the “meaning” of the answer.

The spanned volume can be computed or approximated based on the plurality of distance values 124. This may involve generating, from the plurality of distance values 124, a matrix input for a determinant function, determining an output of the determinant function, and determining the estimate of the volume spanned by the lower-dimensional embeddings from the output of the determinant function. This computation can be formally equivalent to computing the probability of the candidate responses under a learned DPP. That is, in general, the uncertainty associated with any set [symbol] of responses to the same input query can be estimated as the log probability of the set under a learned DPP with marginal kernel K. As noted above, the marginal kernel K can be used to compute the marginal probability of any subset. Thus, representing the collection of m embedding vectors 118 generated for the same input query 112 as a set of embeddings [symbol] ={x₀, . . . , xₘ₋₁} (with dimension m×d), a m×m-dimensional kernel [symbol] = [symbol] ( [symbol] +I)⁻¹ (where [symbol] denotes the principal submatrix of L with respect to [symbol] ) can be computed from the pairwise distance values 124. Thus, the estimate of uncertainty 126 can be computed as the log-determinant of the kernel sub-matrix corresponding to [symbol] as given by log P( [symbol] )=log det [symbol] =log det[ [symbol] ( [symbol] +I)⁻¹].

In a second possibility, the neural network system 110 is configured to cluster the lower-dimensional embeddings 122 into sets of semantically distinct responses based on the determined distance values 124 and to determine the estimate of uncertainty 114 based on the so-obtained clustering data (e.g. based on the number of lower-dimensional embeddings assigned to each cluster). This can involve i) determining the number of clusters, ii) selecting, for each cluster, one of the lower-dimensional embeddings 122 as a respective cluster center for the cluster, and iii) assigning each of the remaining lower-dimensional embeddings to one of the clusters based on the determined distance value between the remaining lower-dimensional embedding and the cluster centers. The above-described DPP framework may be used to implement this clustering efficiently, e.g. a greedy algorithm may be implemented based on the marginal kernel K=(L(L+I)⁻¹ to identify semantically distinct responses in a new set of samples (the term ‘new set of samples’ refers to samples generated at inference time as opposed to samples used during training of the embedding model and the distance model).

In general, the above-described DPP framework can be used to cluster a set of sampled responses [symbol] into semantically distinct clusters and assign each a probability. This can involve finding a subset of responses [symbol] ′⊆ [symbol] that maximizes the probability under the DPP (which is proportional to det [symbol] _{′}) as these represent distinct clusters. The remaining response (i.e. y [symbol] \ [symbol] ′) can then be assigned to the most similar cluster using the pairwise similarity given by the marginal kernel K. Finding the most likely subset (the mode) of a DPP is NP-hard. However, two properties of DPPs enable an efficient greedy approximation: (1) the log-determinant is a submodular function, making it suitable for greedy approximation algorithms and (2) the expected cardinality of subsets sampled under the DPP is analytically tractable.

The number of clusters, denoted with symbol ‘k’, can be determined based on the trace of a matrix formed based on the distance values. More specifically, given a subset [symbol] ⊆ [symbol] , if [symbol] is sampled according to the DPP's marginal kernel matrix K then the expected cardinality of [symbol] is given by trace (K), i.e. [symbol] | [symbol] |=tr(K). Thus, the number of clusters in the plurality of lower-dimensional embeddings may be determined based on the trace of the marginal kernel K=(L(L+1)⁻¹), i.e. k=trace (K). The target cardinality k may be set to k=max(1, round(trace(K))) to ensure that the target cardinality k is a positive integer.

Given the cardinality k many approaches exist to approximately find the maximum a posteriori (MAP) subset of size k. In some implementations, responses (i.e. lower-dimensional embeddings) are greedily added to construct the set of cluster centers [symbol] ′ based on the expected cardinality of [symbol] ′ approximating

$${{\text{?}}^{′}}_{MAP} = {arg max}_{{𝒮}^{′} ⊆ 𝒴 , \vert {𝒮}^{′} \vert = k} det ( {L}_{{𝒮}^{′}} ) .$$

This approach may be implemented iteratively, i.e. by adding examples with high marginal probability until the expected cardinality k is reached.

For example, denoting the subset of cluster centers C and the subset of remaining samples (“lower-dimensional embeddings”) S, k iterations can be performed wherein in each iteration in a sample from S is added to the cluster centers C. The subset of cluster centers C may be initialized with one sample, i.e. at this stage, C={x₀} and S={x₁, . . . , xₘ₋₁} where m is the number of samples (this initialization may be counted as the first iteration since a sample is added to the cluster centers C). In each of the following iterations, one sample from S is selected to be added to the cluster centers C, e.g. the sample from S that gives the highest determinant if added to L indexed by [symbol] , i.e. C←C∪arg maxⱼ log det(L_{C∪S}_{ⱼ}) and S←S\argmax log det(L_{C∪S}_{ⱼ}) (i.e. the sample added to C is removed from S). This results in a set of responses for which each represents a cluster center. The remaining samples can then be assigned to the nearest cluster center in embedding subspace as defined by the respective distance values (as determined via the distance model, e.g. the above-described distance metric or covariance function k(xᵢ, xⱼ)). In this way, semantically distinct sets of responses can be identified in a fully unsupervised manner.

The above-described algorithm for generating clustering data may be implemented according to the following example pseudo-code:

| 1: | C = {x₀} | {subset of cluster “centers”} |
|---|---|---|
| 2: | S = {x₁, ..., xₘ₋₁} | {remaining samples (responses)} |
| 3: | K = L(L + I)⁻¹ | {compute the DPP marginal kernel} |
| 4: | c = max (1, round(trace(K))) | {estimate the expected cardinality} |
| 5: | for i = 1 to (c − 1) do | |
| 6: | C ← C ∪ arg maxⱼ log det (L_{C∪ S}_{ⱼ}) | |
| 7: | S ← S \ arg maxⱼ log det (L_{C∪ S}_{ⱼ}) | {remaining indices} |

| | |
|---|---|
| 8: | end for |
| 9: | for i = 1 to \|C\| do |
| 10: | clustersᵢ = {Cᵢ} |
| 11: | end for |
| 12: | for i = 1 to \|S\| do |
| 13: | {assign to most similar cluster center} |
| 14: | j = argmax L_{i,C} |
| 15: | clustersⱼ = clustersⱼ ∪ Sᵢ |
| 16: | end for. |

The neural network system 110 is further configured to process/analyze the so-obtained clustering data to generate the estimate of uncertainty 126. More specifically, the “semantic” entropy associated with the candidate token sequences (which can be used as a proxy for the estimate of uncertainty) is estimated (or approximated) by counting the number of candidate output sequences in each cluster to yield (after appropriate normalization) probabilities that are highly indicative of whether the generative neural network was “hallucinating” (i.e. didn't know the right output and gave a wrong answer). That is a respective probability for each cluster may be computed by counting the number of responses in each cluster and dividing by the total number of responses. The semantic entropy, denoted SE, associated with the candidate token sequences may be computed from these probabilities, e.g. SE≈ΣPⱼ log Pⱼ where the sum is taken over all clusters and the index “j” denotes the j-th cluster.

In the example of FIG. 1, the neural network system 110 is configured to implement “selective prediction” (i.e. allowing the model to abstain from answering a question if the estimated uncertainty is above a threshold). To this end, the neural network system 110 is configured to determine whether the estimate of uncertainty 126 exceeds a predefined threshold value. If so, the neural network system 110 refrains from outputting one of the candidate output token sequences 116 as the response 114 to the input token sequence 112. Thus, in the example of FIG. 1, when the uncertainty is too high, the neural network system does not provide the user/agent with an answer to the input query (the neural network system may output a corresponding notification or otherwise inform the user/agent).

If the estimate of uncertainty 126 does not exceed the predefined threshold value, the neural network system 110 selects, as output token sequence 114, one of the candidate token sequences 116 based on the distance values 124 (in other implementations, the output token sequence 114 may be randomly selected from the candidate token sequences). As one example, the candidate output token sequence that is associated with the largest eigenvector of the marginal kernel K=(L(L+I)⁻¹) may be selected as output token sequence 114. As another example, the clustering data may be used to select the output token sequence 114. More specifically, the neural network system 110 may randomly select, as the output token sequence 114, one of the candidate output token sequences associated with the cluster that comprises the largest number of lower-dimensional embeddings (i.e. the largest cluster is used as the proposed answer). Alternatively, instead of a single output token sequence, the neural network system 110 may output a (randomly selected) candidate output token sequence from each cluster together with a corresponding estimate of uncertainty associated with that cluster (e.g. the above-described probabilities Pⱼ). For example, in a weather forecast application, the input token query may represent the questions “What will the weather be like tomorrow?”, and output token sequences from different clusters may be output together with the associated uncertainty, e.g. “It will rain”−80%, “It will be sunny” −15%, “There will be a hurricane”−5%. Providing even lower probability answers can be informative and useful to the user, in particular with respect to high risk/reward downstream decisions.

While in the example of FIG. 1, the neural network system abstains from outputting a response when the estimate of uncertainty exceeds the threshold value, in other implementations, the neural network system may instead generate a new output token sequence which is output to the user/agent as response to the input query. That is, in these cases, the neural network system does not output one of the candidate output token sequences, but obtains, in response to the estimate of uncertainty exceeding the threshold value, a further output token sequence.

The further output token sequence can be obtained in different ways. In one possibility, the neural network system may attempt to reduce the uncertainty by gathering more information either from the user or by calling an external tool (e.g. performing Google search). Thus, the neural network system may obtain a further input token sequence (e.g. by requesting clarification or other helpful information from the user) and may process the initial input token sequence and the further input sequence to generate the further candidate output token sequence, which is output, as the response to the input token sequence. In this possibility, the further candidate output token sequence is more suitable (i.e. better) response to the initial input query compared to the previously generated candidate output sequences, because the further candidate output token sequence is generated based on improved input query (i.e. the initial input query and the further input token sequence).

In another possibility, when the estimate of uncertainty exceeds the threshold value, the input token sequence may be input into a second generative neural network (not shown) which is more capable than the generative neural network 120 (e.g. the second generative neural network may have a larger number of learnable parameters than the generative neural network 120, e.g. at least 10 times more learnable parameters). In this case, the second generative neural network may generate an output token sequence (e.g. as response to the input query 112) which is output to the user/agent as response to the input query. The output of the second generative neural network is more likely to be correct because the second generative neural network is more capable (of course the above-described techniques to estimate the uncertainty of generative neural network may also be applied to the second generative neural network). This enables efficient use of computing resources since the larger model is only called when needed (i.e. when the smaller model cannot reliably answer).

In yet another possibility, the generative neural network is in communication (via a network such as the Internet) with at least one software agent (to “integrate” the capabilities of the agent with the generative neural network, i.e. the agent provides an extra layer of capability or additional functionality that is not available from the output of the generative neural network itself). The agent may be an AI-based software agent/assistant or a conventional software tool (e.g. search engines, calendar applications, web browsers, travel planning applications, internet of things devices, machine translation applications and the like). Thus, the neural network system may be configured to, in response to determining that the estimate of uncertainty exceeds the threshold value, transmit a query to the agent. In response to the query, the agent may transmit response data for the transmitted query. Thus, when the response data item is received, the generative neural network processes the input token sequence and the response data item to generate a further candidate output token sequence which is output, as the response to the input token sequence. These possibilities may be combined as appropriate.

While in the example of FIG. 1, the neural network system checks whether the obtained estimate of uncertainty meets an uncertainty criterion (e.g. exceeds a threshold value), in other implementations, the neural network system may utilize the estimate of uncertainty (additional or alternatively) in a different manner to improve its output. That is, there are many ways in which the neural network system can utilize the estimate of uncertainty to improve the output response to the user or software agent. As an example, the neural network system may output the estimate of uncertainty to the user or the software agent that provided the input token sequence. The estimate of uncertainty may be expressed as a probability (e.g. in percentage) that the generative neural network answers the input query correctly. This allows the user/agent to make an informed decision whether it is safe to use/rely on the output of generative neural network. In this case, the neural network system may select, as the output token sequence, one of the candidate output sequences, either randomly or based on the distance values as described above.

Optionally, the generative neural network can be implemented on a parallel or distributed processing system comprising a plurality of processing units and is configured to process a batch of input tokens in parallel. In these cases, using the generative neural network to process the input token sequence may comprise generating a batch of input tokens comprising repeated copies of part or all of the input token sequence (one copy per candidate output token sequence) and processing the batch of input tokens in parallel, using the plurality of processing units, to generate the plurality of candidate output token sequences and the associated embedding vectors, comprising processing the batch of input tokens using the generative neural network to generate, in parallel, an output token for each candidate output token sequence. Thus, in broad terms, the (or part of the) input token sequence is repeated, say n times, across multiple notional slots in the batch (in some implementations with some padding to allow the token sequence to be extended). The batch is processed, in parallel, by the generative neural network, to generate n output tokens for the respective n candidate output sequences, and the associated respective embedding vectors. This can be done by randomly sampling each output token, e.g. from a respective distribution generated by the generative neural network. These new output tokens are processed autoregressively by the generative neural network (as a batch) to generate the next n output tokens for the n respective candidate output sequences, and so forth. In these implementations, the computer system 100 may further comprise one or more tensor processing units or one or more graphics processing units (or another type of neural network accelerator hardware) to implement the above-described parallel processing.

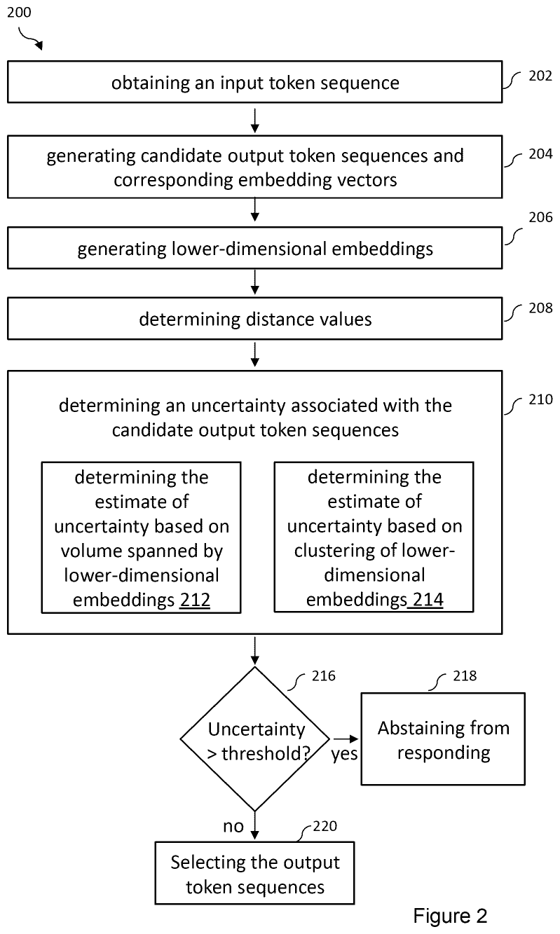

FIG. 2 is a flow diagram of an example process 200 of using a neural network system configured to process an input query comprising an input token sequence. The process 200 of FIG. 2 may be implemented by one or more computers in one or more locations. For example, the process 200 may be implemented by the system of FIG. 1, and for convenience the process is described with reference to FIG. 1.

At an initial step 202, the input token sequence 112 is obtained based on input from a user (e.g. via a user interface) or from a software application in communication with the neural network system 110. An interface may be provided between (i) the user or the software application, and (ii) the neural network system 110 to generate the input token sequence 112 from the input from the user or software application (e.g. if the input is a string of characters, raw image data (e.g. an image captured by a camera) or audio data (e.g. audio data captured by a microphone). For example, the interface may include an embedding system for converting characters (e.g. typed by a user) into text tokens, a set of pixel values defining the image into image tokens, and/or frequency/amplitude data into audio tokens.

At step 204, using the trained generative neural network 120, m candidate output token sequences 116 (m>1) are generated for the input token sequence 112. Further, a corresponding embedding vector is generated for each candidate output token sequence. As described above with reference to FIG. 1, the embedding vectors 118 can be generated based on internal activation of the trained generative neural network 120, e.g. the embedding vectors 118 can be generated based on the output of a hidden layer of the trained generative neural network 120 (e.g. by averaging the score vectors for the tokens in the output token vocabulary across the positions in the candidate output token sequence).

At step 206, the embedding vectors 118 are processed, using the embedding model 130, to generate corresponding lower-dimensional embeddings 122. As noted above, the lower-dimensional embeddings 122 represent the candidate output token sequences in a semantically meaningful vector space, i.e. an embedding subspace that encodes semantic similarity between the embedding vectors. At step 208, pair-wise distance values 124 are generated for the lower-dimensional embeddings. As described above with reference to FIG. 1, the distance model 140 can be used to generate the pair-wise distance values 124, e.g. using Eq. (1).

At step 210, the distance values 124 are processed to determine an estimate of uncertainty 126 associated with the plurality of candidate output token sequences 116 based on the plurality of distance values 124. As described above, this can be achieved in different ways. In some embodiments, the estimate of uncertainty 126 is generated based on the volume spanned by lower-dimensional embeddings 122 in the semantically meaningful vector space (step 212) as described above, e.g. by computing the log-determinant of the marginal kernel K corresponding to the set of candidate output token sequences 116. In other embodiments, clustering data is generated by performing a clustering algorithm/analysis on the candidate output token sequences 116 based on the distance values 124 (i.e. each candidate output token sequences is assigned to one cluster of a plurality of clusters) and the estimate of uncertainty 126 is generated based on the clustering data (step 214), as described above.

The so-generated estimate of uncertainty 126 can be used in many ways to improve the output provided to the user. In the example process 200, the estimate of uncertainty 126 is used to implement selective prediction (to prevent incorrect answers), i.e. to abstain from outputting one of the candidate output token sequences to the user if the estimate of uncertainty 126 satisfies a threshold criterion, e.g. exceeds a predefined threshold value (step 218). If the estimate of uncertainty 126 does not satisfy the threshold criterion, e.g. does not exceed the predefined threshold value (step 220), one of the candidate output token sequences is output to the user/agent as response to the input query. As described above, the output token sequence 114 can be selected in many ways. For example, in some embodiments, the candidate output token sequence associated with the largest eigenvector of the marginal kernel K is selected as output token sequence 114. In other embodiments, one of the candidate output token sequences associated with the largest cluster is selected as output token sequence 114.

In other implementations, instead of refraining from outputting a response, step 218 may comprise generating a further output token sequence and outputting the further output token sequence as output token sequence. As described above, in some embodiments, the further output token sequence may be generated based on additional information, e.g. gathered from the user/agent that provided the initial input token sequence 112 or from a further software agent. In other embodiments, the further output token sequence is generated by a second (more powerful) generative neural network.

It is to be understood that the process 200 may be implemented using parallel or distributed processing. In these cases, the plurality of candidate output token sequences and the associated embedding vectors may be generated (step 204) in parallel (rather than sequentially). For example, multiple instances of the generative neural network 120 may be executed in parallel to process the input token sequence 112 to generate candidate output token sequences 116 and the associated embedding vectors 118 in parallel. This means that each instance of the generative neural network generates a respective subset of candidate output token sequences and the associated embedding vectors in parallel. The instances of the generative neural network may be executed using a plurality of (remote) computers (“workers”). Thus, in these cases, the process further comprises steps of distributing the input token sequence to each of “workers” and using the “workers” in parallel, to process the input token sequence to generate the plurality of candidate output token sequences and the associated embedding vectors in parallel. As there are no dependencies on the candidate output token sequences (and the associated embedding vectors) within the plurality of candidate output token sequences, the generation of the candidate output token sequences and the associated embedding vectors can be carried out on parallel and distributed processing systems more easily. There need not be any special data or resource allocation considerations because each candidate output token sequence is generated independently. In some implementations, each “worker” may also perform step 206, i.e. generate the corresponding lower-dimensional embeddings. Thus, the process is particularly adapted for parallel and distributed processing systems and accelerator hardware.

FIG. 3 shows a system 300 implemented as computer programs on one or more computers in one or more locations, for training the above-described embedding model 120 (defined by a plurality of trainable parameters) and the distance model 130 (defined by at least one trainable parameter). The training of the embedding model and distance model enables the system to project high-dimensional model activations into a semantically meaningful subspace. In broad terms, the training is designed to ensure that the spatial proximity of lower-dimensional embeddings accurately reflects the semantic similarity of the corresponding candidate output token sequences. The training can involve fitting a determinantal point process (DPP), specifically an L-ensemble, to training data comprising semantically distinct subsets. As noted above, a DPP is a probabilistic model that assigns higher probabilities to subsets of items that are diverse. In this context, diversity corresponds to the volume spanned by the lower-dimensional embeddings in the latent subspace.

While in the following the system 300 will be described as implementing a training process that jointly trains the embedding model 120 and the distance model 130, it is to be understood that in other implementations, the system may be used to individually train the embedding model 120 or the distance model 130 (in which case, the parameters of the other model are not updated during the training process).

The system 300 comprises training data 310, a training engine 320, the (to-be-trained) embedding model 120 and the (to-be-trained) distance model 130. The system 300 is configured to process the training data 310 to iteratively update (i.e. train) the parameters of the embedding model 120 and the distance model 130 (e.g. in a self-supervised manner). More specially, in each one of a plurality of iterations (or “training steps”), the system 300 generates a corresponding parameter update 302 for the parameters of the embedding model 120 and the distance model 130. The update 302 is generated by the training engine 320 based on outputs of the embedding model 120 and the distance model 130 generated for input data selected from the training data 310.

The training data 310 is a dataset of training data comprising a plurality of training examples 312. Each training example 312 comprises i) a plurality of training embedding vectors derived from the above-described trained generative neural network 110 (e.g. the generative neural network's internal activations) for the same input token sequence, and ii) labels that indicate which semantic cluster each embedding vector belongs to. Thus, each training example is associated with a specific input token sequence (e.g. a specific prompt). In the following it is assumed that the training data 310 comprises n training examples 312 (n≥1) each comprising m labeled responses, i.e. labeled training embedding vectors (m>1). In other words, the training examples 312 comprise a collection of semantically distinct subsets [symbol] ={ [symbol] ᵢ} responses, where [symbol] denotes the subsets corresponding to each prompt i (i.e. the index i indicates the i-th training example).

The labels can be generated without manual annotation. More specifically, to establish a “ground truth” for semantic similarity without manual annotation, a further, often more capable, generative neural network (not shown) is employed to perform pairwise bi-directional entailment. Two responses are considered semantically consistent if they both imply each other. This process, often implemented using the computationally efficient Leader algorithm, assigns each response to a specific semantic cluster. These cluster assignments serve as pseudo-labels for the training embedding vectors. Thus, using a further generative neural network to perform pairwise bi-directional entailment ensures that semantically consistent responses are grouped together in the training set. These semantic clusters are labeled semantically diverse subsets from the larger set of responses.

The system 300 is configured to provide the training embedding vectors of the training examples 312 to the embedding model 120 to generate corresponding training lower-dimensional embeddings. The system 300 is further configured to pass the training lower-dimensional embeddings to the distance model 130 which generates pairwise distance values 306 for every possible pair within each training example. This calculation typically employs a kernel or covariance function that measures the distance in the semantically meaningful latent subspace as described above with reference to FIG. 1.

The training engine 320 is configured to perform an iterative optimization process using the distance values 306. In each training step, the training engine randomly samples, for each training example, a single lower-dimensional embedding from each semantic cluster. A loss function 322 is then evaluated based on the distance values for the sampled and for the remaining training embeddings. The loss function can comprise a contrastive loss derived from the DPP framework, e.g. calculated as the negative marginal log-likelihood. The loss function may encourage larger distances between semantically distinct responses (increasing the determinant of the sampled subset) while simultaneously regularizing the entire embedding space (minimizing the determinant of all possible subsets).

More specifically, in each training step, the training engine randomly samples n labeled diverse subsets from a set of m responses that may be used to compute an average negative log likelihood loss, denoted [symbol] by for the dataset,

$$\text{?} ℒℒ = - \frac{1}{n} {\sum }_{i = 1}^{n} [ log det ( {L}_{{𝒴}_{i}} ) - log det ( {L}_{i} + I ) ] \qquad Eq . ( 2 )$$

where [symbol] is the submatrix indexed by the subset of response indices [symbol] ᵢ and Lᵢ is the kernel over all responses for the i-th training example. Optimizing Eq. (2) can be considered to resemble contrastive learning where the first term log det( [symbol] ) pushes objects in [symbol] apart in latent space, while the second term log det(Lᵢ+I) pulls everything closer together. The second term provides effective regularization, preventing the need for any additional regularization terms such as priors on the parameters of the kernel. It is to be understood that the DPP model is fitted only once (i.e. during training but not during inference), i.e. inference is amortized on a training set. Further, in some implementations, the loss function may be evaluated for each training example separately, in which case the loss function simplifies to log P_{L}( [symbol] ᵢ)=log det( [symbol] )−log det(Lᵢ+I).

The training engine 320 is configured to generate the parameter updates 302 based on the evaluation of the loss function 308. The parameter updates 302 can be backpropagated to adjust the weights of the embedding model 120 and the distance model 130. This joint training ensures that the embedding model eventually learns an efficient, amortized mapping where spatial proximity in the latent space directly corresponds to semantic similarity, enabling the system to quantify uncertainty at inference time without needing a large number of computationally expensive model calls. The Adam optimizer (or any other suitable (gradient descent) optimization algorithm) may be used to compute the updates 302 for the parameters of the embedding model 120 and the distance model 130 from the negative log likelihood loss. The parameters of the kernel, i.e. the hidden dimensionality of the embedding model 120 and the output dimensionality, i.e. the low-dimensional projection, may be determined via a random search over hyperparameters. Since the marginal likelihood is used, the hyperparameters may be selected according to highest marginal likelihood on the training set.

FIG. 4 is a flow diagram of an example process 400 for training both or at least one of the embedding model 120 and the distance model 130. The process 400 of FIG. 4 may be implemented by one or more computers in one or more locations; for convenience the process is described with reference to FIG. 3.

At step 402, a training dataset 310 of training examples 312 is obtained. As noted above, each training example, each training example 312 comprises of a plurality of training embedding vectors derived from a generative neural network's internal activations for a specific prompt, paired with labels that indicate which semantic cluster each response belongs to. The training examples can be generated by sampling m responses (i.e. output token sequences and corresponding embedding vectors) from the generative neural network 120 for each of n input token sequences.

Labels for the so-obtained responses may be generated by using a further generative neural network to perform a pairwise bi-directional entailment method to cluster the responses belonging to the same prompt. However, other methods may be used to obtain the labels.

The training embedding vectors are processed by the embedding model 120 (step 404) to generate the lower-dimensional embeddings 304. The lower-dimensional embeddings 304 are then passed to the distance model 130 which generates pairwise distance values 306 for each pair within each training example (step 406). At step 408, a plurality of training steps is performed. In each training step, for each training example, a single lower-dimensional embedding is sampled for each cluster associated with the training example. At step 410, a loss function (e.g. Eq. 2) is evaluated based on the distance values associated with the sampled associated lower-dimensional embeddings. At 412, the adjusting trainable parameters of the embedding model and/or of the distance model are updated based on the evaluated loss function as described above.

The performances of two example implementation of the neural network system 110 of FIG. 1 trained using the system 300 of FIG. 3 has been experimentally investigated. The experiments aim at assessing the efficacy of the proposed techniques to measure uncertainty and apply this to important downstream tasks. To this end, the empirical evaluation is framed as “selective prediction” for confabulation (“hallucination”, fabrication, etc.) mitigation within question-answering tasks, by allowing the model to abstain from answering a question if the estimated uncertainty exceeds a certain threshold. By varying this threshold, precision-recall curves, receiver-operator characteristic (ROC) curves have been traced out, and the Area Under the ROC (AUROC) metric has been computed as figure of merit.

In the example implementations, the generative neural network is an instruction-tuned, open-source LLM (Gemma2 9B), the embedding model is a single-hidden layer neural network (implementing a Gaussian Error Linear Unit (GELU) activation function), and the distance model implements Eq. (1). The parameters of the GELU projection have been learned jointly with the kernel hyperparameters to minimize the negative Marginal Log-Likelihood of the DPP, using the Adam optimizer.

The first example implementation generates the estimate of uncertainty based on the volume spanned by the lower-dimensional embeddings (step 212 of FIG. 2) while the second example implementation generates the estimate of uncertainty based on clustering of the lower-dimensional embeddings (step 214 of FIG. 2).

Experiments have been conducted using six widely used question answering (QA) benchmark datasets, selected to have overlap with existing literature and cover different challenges within QA tasks: TruthfulQA (Lin et al., 2022), GSM8k (Cobbe et al., 2021), TriviaQA (Joshi et al., 2017), BioASQ (Tsatsaronis et al., 2015), NQ Open (Lee et al., 2019), and Squad (Rajpurkar et al., 2016). For each benchmark dataset, 75%-25% train/test splits have been created and the model hyperparameters with the best marginal likelihood on the training set have been selected.

To implement step 402 of FIG. 4, i.e. to obtain semantically distinct subsets to fit the DPP, pseudo-labeling is performed using a further generative neural network, namely the publicly available Gemini 1.5 Flash model (Google Gemini Team et al., 2024). More specifically, for a given data set of n prompts, m responses are sampled from the LLM (Gemma2 9B). These responses are then clustered using pairwise bidirectional entailment, i.e. for two statements Sa; Sb, Sa and sb entail one another if and only if they both imply each other. Using this as similarity and cluster membership condition, elements are added to the same cluster when they entail each other via the computationally efficient Leader algorithm. This yields a collection of clusters assignments for each prompt, C:=C₀; . . . ; Cₙ, which is used to pseudo-label the responses and serve as a proxy for ground truth semantic similarity. The embedding model and the distance model are then trained by optimizing the marginal likelihood of the DPP conditioned on these labeled subsets as described above with reference to FIGS. 3 and 4.

Corresponding experiments have been conducted using three comparative methods: “Semantic Entropy” (Farquhar et al., 2024) which relies on a computationally intensive, bidirectional entailment-based clustering approach (clusters are assigned probabilities by counting the number of responses in each cluster and normalizing. Standard Shannon-entropy is computed from these probabilities), “Linear Probe” (Kossen et al., 2024) which involves fitting a linear regression from the averaged and whitened embedding representation of a single response to the entropy as computed in “Semantic Entropy”, and “EigenScore” (Chen et al., 2024, Eq. 5) which computes the log-determinant of a centered linear kernel on the same whitened embeddings.

Further, also two simplified ablations of the example implementations have been implemented. In the ablation implementations, the DPP model is fitted directly on response embeddings (i.e. the embedding model is taken to be the identity rather than a single layer NN with learned parameters), and the kernel function (Eq. (1)) is used to optimize the hyperparameters and the scaling parameters for each dimension.

FIG. 5 shows a graph illustrating AUROC values aggregated over the six benchmark datasets. The reference numerals 501 and 502 indicate aggregated AUROC values for the first and second example implementation respectively. The reference numerals 503, 504 and 505 indicate aggregated AUROC values for the comparative methods “Semantic Entropy”, “Linear Probe” and “EigenScore” respectively. The reference numerals 506 and 507 indicate aggregated AUROC values for the ablated version of the first and second example implementation respectively. It can be seen that the first and second example implementations are top scoring methods in terms of AUROC. It can also be seen that the ablated versions of the example implementations score poorly which demonstrates the benefits of using the above-described embedding model.

Beyond accuracy, the experiments highlight a large gain in computational efficiency; for instance, on the TriviaQA test set, the first example implementation achieved a runtime of approximately 0.00186 seconds and the second example implementation achieved a runtime of approximately 29.6 seconds. In contrast, the comparative method “Semantic Entropy” required a runtime of 57.4 hours. This is because the proposed techniques require, at inference time, m calls of the generative neural network, while “Semantic Entropy” requires m² calls.

### Generative Neural Network

As mentioned above, the described systems and techniques may be applied to a wide range of different types of input token sequence and output token sequence. In implementations of the described techniques the tokens may represent, characterize, or encode any type of information in a sequence e.g. stream of data. The term “represent” is used, below, generally to refer to any way in which a token can encode part of a sequence. The tokens may include marker tokens, such as a start of sequence token, an end of sequence token, and a separator token (indicating a separation or break between two distinct parts of a sequence). The tokens may, but need not be, drawn from a defined vocabulary of tokens.

In some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g. for question answering, or for text completion. In some implementations the input sequence may represent text in a natural language and the output sequence may represent text in the same natural language, e.g. a longer item of text. For example in some implementations the input sequence may represent text in a natural language and the output sequence may represent the same text with a missing portion of the text added or filled in. For example the candidate output token sequences may represent a predicted completion of text represented by the input sequence. Such an application may be used, e.g. to provide an auto-completion function e.g. for natural language-based search. In some implementations the input sequence may represent a text in a natural language e.g. posing a question or defining a topic, and the output sequence may represent a text in a natural language which is a response to the question or about the specified topic.

As another example the input sequence may represent a first item of text and the output sequence may represent a second, shorter item of text e.g. the second item of text may be a summary of a passage that is the first item of text. As another example the input sequence may represent a first item of text and the output sequence may represent an aspect of the first item of text e.g. it may represent an entailment task, a paraphrase task, a textual similarity task, a sentiment analysis task, a sentence completion task, a grammaticality task, and in general any natural language understanding task that operates on a sequence of text in some natural language e.g. to generate an output that classifies or predicts some property of the text. For example some implementations may be used to identify a natural language of the first item of text, or of spoken words where the input is audio (as described below).

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

Some implementations may be used for speech recognition. In such applications the input sequence may represent spoken words and the output sequence may represent a conversion of the spoken words to a machine-written representation e.g. text. Then the input tokens may comprise tokens representing an audio data input including the spoken words e.g. characterizing a waveform of the audio in the time domain or in the time-frequency domain. The output tokens may represent words, wordpieces, characters, or graphemes of a machine-written representation of the spoken input, e.g. text that is representing a transcription of the spoken input.

Some implementations may be used for handwriting recognition. In such applications the input sequence may represent handwritten words, syllabograms or characters and the output sequence may represent a conversion of the input sequence to a machine-written representation e.g. text. Then the input tokens may comprise tokens representing portions of the handwriting and the output tokens may represent words, wordpieces, characters or graphemes of a machine-written representation, e.g. text of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g. tokens characterizing a portion of a waveform of the speech in the time domain or in the time-frequency domain, or phonemes.

In some implementations the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (RoIs) in the image, optionally including one or more tokens for global image features. For example an image may be encoded using a neural network to extract Rol features; optionally (but not essentially) a token may also include data, e.g. a position encoding, representing a position of the Rol in the image. As another example, the tokens may encode color or intensity values for pixels of an image. As another example, some image processing neural network systems e.g. autoregressive systems, naturally represent images as sequences of image features. As another example, a transformer-based generative neural network system as previously described may be used to process images instead of or as well as text (e.g. if trained on images instead of or as well as text).

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video e.g. described by the text, or providing a visual answer to a question posed by the text, or providing a visualization of a topic of the text. In another example the input sequence may comprise a sequence of input tokens representing an image or video, and the output tokens may represent words or wordpieces, or characters representing text e.g. for a description or characterization of the image or video, or providing an answer to a question posed visually by the image or video, or providing information on a topic of a topic of the image or video.

In some other implementations both the input sequence and the output sequence may represent an image or video, and both the input tokens and the output tokens may represent a respective image or video. In such implementations the method/system may be configured to perform an image or video transformation. For example the input sequence and the output sequence may represent the same image or video in different styles e.g. one as an image the other as a sketch of the image; or different styles for the same item of clothing.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

In some implementations the input sequence represents a sequence of actions to be performed by an agent e.g. a mechanical agent (e.g. robot) in a real-world environment implementing the actions to perform a mechanical task. The candidate output token sequences may comprise a modified sequence of actions e.g. one in which an operating parameter, such as a speed of motion or power consumption, has a limited value; or one in which or safety or other boundary is less likely to be crossed. Then both the input tokens and the output tokens may represent the actions to be performed. The proposed techniques can ensure that the agent doesn't follow a hallucinated instruction. For example, when the estimate of uncertainty is determined to be above a threshold value, the system may output automated (i.e. predefined) fallback instructions.

In some implementations the input sequence represents a sequence of health data and the output sequence may comprise a sequence of predicted treatment. Then the input tokens may represent any aspect of the health of a patient e.g. data from blood and other medical tests on the patient and/or EHR (Electronic Health Record) data; and the output tokens may represent diagnostic information e.g. relating to a disease status of the patient and/or relating to suggested treatments for the patient, and/or relating to a likelihood of an adverse health event for the patient.

### Language Models

As mentioned above, the generative model neural network may be a language model neural network. In general, a language model neural network is a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data.

It is surprising, but well-established, that large language model neural networks can perform tasks that they were not explicitly trained to perform. For example they can perform translation tasks (provided that the training corpus included words in different languages), arithmetic, and many other tasks.

A language model neural network can be made to perform a particular task by providing a natural language description of the desired response as an input or “prompt” (input sequence). In some cases, the prompt may be a few-shot prompt where a few, e.g., 1 to 10, examples of a query and an example output are provided in the text prior to the actual query.

Instead or in addition, a language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed.

The language model neural network may be a large language model neural network, e.g., one that has greater than 1 billion, 10 billion or 100 billion trained parameters. The language model neural network may have been trained on greater than 10 billion, 100 billion or 1000 billion words or tokens representing words or other text tokens, e.g., sub-words (also known as “word pieces”).

In some implementations, the language model neural network is an autoregressive transformer neural network, where a transformer neural network is characterized by having a succession of self-attention neural network layers. A self-attention neural network layer has an attention layer input for each element of the input and is configured to apply an attention mechanism over the attention layer input to generate an attention layer output for each element of the input; there are many different attention mechanisms that may be used. In some implementations the language model neural network can be a mixture-of-experts model.

Generally, an attention mechanism maps a query and a set of key-value pairs to an output, where the query, keys, and values are all vectors. The output is computed as a weighted sum of the values, where the weight assigned to each value is computed by a compatibility function e.g. a dot product or scaled dot product, of the query with the corresponding key. For example an output of the attention mechanism may be determined as

$$softmax ( \frac{{QK}^{T}}{\sqrt{d}} ) V$$

where d is a dimension of the key (and value) vector, where query vector Q=XW^{Q}, key vector K=XW^{K}, and value vector V=XW^{V}, with input sequence X and learned query matrix W^{Q}, learned key matrix W^{K}, and learned value matrix W^{V}. The output may be processed by one or more fully-connected, feed forward neural network layers. A layer norm operation may also be incorporated. The attention mechanism may implement multi-head attention, that is it may apply multiple different attention mechanisms in parallel. The outputs of these may then be combined, e.g. concatenated, with a learned linear transformation applied to reduce to the original dimensionality if necessary.

As a particular example the generative neural network can comprise a multimodal model in which one or both of the model input (i.e. input sequence) and the model output (i.e. output sequence) comprise an image or audio. For example the multimodal machine learning model may be configured to process an input sequence comprising visual tokens representing pixels of a still or moving image (which here may include a point cloud image), and/or data representing an audio waveform e.g. values or features of the audio waveform such as audio tokens, and/or text tokens representing a sequence of text, to generate an output sequence e.g. comprising text tokens representing the still or moving image or audio waveform, and/or comprising a sequence of intensity value inputs for the pixels of an image or a sequence of values defining an audio waveform. A visual token may, e.g., represent multiple pixels in a region of the image, e.g. as features of the region. Such a multimodal model may perform any of the previously described tasks, e.g. using a multimodal input, or by providing a multimodal output, or by converting between different input and output modes (e.g. text/image/audio). For example it may generate text representing, describing (e.g. captioning), or otherwise characterizing an image or audio input, e.g. by answering a question related to the image or audio input, e.g. relating to a future e.g. physical prediction of a state of objects represented by the image or audio. As another example it may generate an image or audio represented, described, or otherwise characterized by a text input, or otherwise in response to the text input, e.g. representing an image or audio answer to a text question.

In some implementations the neural network layers of the blocks are stored on a user computing device (i.e., local to the user), such as a mobile device, e.g., a mobile phone, tablet or a smart speaker, and the adapter subnetworks are stored on one or more server devices (i.e., remote from the user). Thus, parameters of the adapter subnetworks may not be accessible to users and can therefore remain private.

In other implementations the adapter subnetworks are stored on the user computing device and the neural network layers of the blocks are stored on one or more server devices. Thus, parameters of the adapter subnetworks may not be accessible only to one or more selected users. Thus, the adapter subnetworks may be used to “personalize” the generative neural network for a particular one or more users.

A user computing device may be provided an input mechanism that enables user input from the user in a natural language and an output mechanism that provides a system output to the user in the natural language. The input and output mechanism may comprise, e.g., a keyboard and display. Also or instead the input and output mechanism may comprise a speech-based mechanism. For example the input mechanism may comprise a system configured to input audio data characterizing a speech waveform of speech representing the input from the user in the natural language and configured to convert the audio data into tokens representing the speech in the natural language, e.g. representing a transcription of the spoken input. The output mechanism may comprise a system configured to receive tokens representing the output to the user in the natural language and a system configured to convert the received tokens into audio data representing a waveform of speech representing the output to the user in the natural language, i.e. representing spoken words.

In some implementations the input sequence comprises one or more natural language statements relating to an environment, in particular a real-world environment, and includes a natural language request relating to the environment. Similarly the output sequence may be a natural language reply or natural language output statement that also relates to the environment i.e. it provides information relating to the environment, in some implementations relating to or specifying actions to be taken in the environment.

In some implementations the environment is a real-world environment and the method (or a corresponding system) is used for diagnosing a fault in a mechanical system operating in the real world environment. Then obtaining the input sequence may comprise obtaining from one or more sensors, e.g. as described below, one or more observations of the mechanical system (which here includes observations of the operation of mechanical system). These are processed, e.g. as described below, to generate a natural language representation of the one or more observations that is used to provide one or more of the natural language statements of the input sequence. In these implementations the natural language request relates to the operation of the mechanical system and the natural language reply or the natural language output statement is used to identify a fault in the mechanical system. For example the request may comprise a general question such as “Is the system working correctly?” or “What is wrong with the system?” or a specific request such as “Is there a fault with component X?”. The ability to hold a dialogue with an agent comprising generative neural network facilitates homing in on a particular fault diagnosis. The diagnosis can use information stored within the trained language generation neural network and can use the ability to search an external data store to supplement the stored information with more comprehensive or more recent information as needed.

As another example, the environment can be a computer security monitoring environment, e.g., the system can be deployed as part of a system that monitors the security of one or more computers. For example, the environment may be a computer network security monitoring environment, and the system can be deployed as part of a system that monitors the security of one or more computers on a computer network, e.g. a wireless network, a cellular network, a local area network and/or the internet. As another example, the environment may alternatively or additionally be a computer system security monitoring environment and the system can be deployed as part of a system that monitors the system for the presence of computer viruses and/or an unresolved software vulnerability, e.g. a zero-day exploit. A software vulnerability may be resolved by updating the software (e.g. patching) and/or removing (e.g. uninstalling) the software from the computer system. In these examples, the natural language request can query whether a computer security incident has been resolved (e.g., “has the incident been resolved?”) and the input sequence may comprise relevant statements from system logs, i.e., that are potentially relevant to the event being queried. A computer security incident can be, e.g., a data breach, an unauthorized log-in or other access of a secured system, a detection of a computer virus or detection of a software vulnerability. The incident can be “resolved” when the underlying incident is no longer a threat to the security of the computer system e.g., the computer virus has been removed, the access to the secured system has been removed, the data breach has been mitigated, or the software having the vulnerability has been updated or removed. The system can use the input sequence to generate a reply to the request that comprises a natural language statement indicating whether the incident has been resolved, optionally displaying evidence used to determine this.

The input sequence may include one or more of: code snippets from the software code, system logs, program logs, or other artifacts that should be left on the computer by running the program, or verification rules that represent requirements for the execution of the software program, or natural language statements describing the computer system on which the software executes. In general the input sequence may include relevant statements, i.e., statements that are potentially relevant to the event being queried.

In some implementations obtaining the input sequence may comprise obtaining, from the system logs, the data characterizing the computer network, or both, or from other data as described above, one or more observations of the computer network (which here includes computers on the network), and processing the one or more observations to generate a natural language representation of the one or more observations. The natural language request may relate to the computer security incident or to the secure operation of the computer network. The method may include using the natural language representation of the one or more observations to provide one or more of the natural language statements describing the computer network, and using the natural language reply or the natural language output statement to identify a security status of the computer network or a security flaw in the computer network.

As another example, the environment can be a software testing or evaluation environment, e.g., the system can be deployed as part of a system that tests software before deployment or that evaluates already-deployed software to identify bugs. In these examples, when the system tests software before deployment, the natural language request can ask whether the software will execute as intended, and the input sequence can include code snippets from the software code and, optionally, natural language statements describing the computer system on which the software will execute. The system can then use the input sequence to generate a reply that indicates whether the code will execute as intended, optionally displaying evidence used to determine this. When the system monitors the execution of code after deployment, the natural language request can ask whether a software program, or a portion of a software program, has executed as intended, and the input sequence can include one or more of: code snippets from the software code, system logs, program logs, or other artifacts that should be left on the computer by running the program, or verification rules that represent requirements for the execution of the software program, or natural language statements describing the computer system on which the software executes. The system can then use the input sequence to generate a reply that indicates whether the code has executed as intended, optionally displaying evidence used to determine this. As a particular example, the software program can be part of the boot up of a computer, and the system can generate a reply each time that the computer starts up to verify whether the computer will function correctly after start up.

As another example, the environment can be an educational environment, e.g., the system can be deployed as part of an education software program that assists a user in learning or practicing one or more corresponding skills. In these examples, the input sequence can include natural language statements describing or referencing a scenario or scene in a real-world or imagined environment, and the request can be a question about the scenario or scene.

As another example, the environment can be an information retrieval environment, e.g., the system can be deployed as part of a search engine or other software that allows a user to search for information in a corpus of documents, e.g., the Internet or another electronic document corpus. In these examples, the request can be any appropriate natural language question, and the reply can optionally include evidence such as include relevant statements from the corpus of documents, e.g. as identified by searching the corpus using conventional information retrieval techniques.

In some implementations, the language model neural network is a visual language model (VLM). In general, the VLM may process input sequences comprising tokens that each represent natural language or (a part of) an image or video to generate output tokens that each represent natural language or (a part of) an image or video. For example, the VLM may be configured to describe an image or video using natural language, e.g., to perform an image or video captioning task. As another example, the VLM may be configured to process input tokens representing an image and text tokens representing a query about the image or a request to modifying the image, and to generate output tokens representing an answer to the query or representing a version of the image that has been modified in accordance with the request. The VLM may generate output tokens representing an image or video that is generated in response to input tokens providing a visual and/or audio and/or textual description of a desired image or video.

In some implementations, the “language” of the language model is not a natural language such (e.g. English), but may instead be a text-based encoding describing an entity or class of entities, e.g. a chemical or biological entity, such as a chemical structure or molecule. For example, the text-based encoding may be an sequence of tokens that defines a molecule or protein, e.g. a sequence specifying an arrangement of atoms or chemical functional groups in a molecule, or the amino acid residues of a protein. The language model may be referred to as a chemical and/or biological language model in such cases. The input for the language generation neural network may therefore be an input string defining a chemical (e.g. protein) structure and the output may be an output string defining a different chemical structure from the input string. The strings may be in the Simplified Molecular Input Line Entry System, SMILES, format, for example.

In some implementations, the language model neural network may be used to interact with a human user of a digital assistant such as a smart speaker, smart display, or other device. For example, information defining a task can be obtained from the digital assistant, and the digital assistant can be used to instruct the user to perform the task. For example, this may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task.

As an illustrative example, a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly, the assistance control subsystem and output to the user an indication of the task to be performed, capture, using the observation capture subsystem, visual or audio observations of the user performing the task, determine from the above-described answer whether the user has successfully achieved the task.

In response, the digital assistant can progress to a next task of the series of tasks and/or control the digital assistant, e.g. to stop capturing observations.

### Multimodal Models

The generative neural network can be a multimodal machine learning model, such as a VLM, as mentioned above. For example, the input sequence may comprise tokens of one or more modalities and the output sequence may comprise tokens of one or more modalities, which may be the same as of different from the one or more modalities of the tokens of the input sequence. In general, a multimodal machine learning model has a multimodal input configured to receive a first multimodal input of a first modality and a second multimodal input of a second, different modality. As used herein a “modality” refers to a type of data, and thus a multimodal machine learning model is one that can process multiple different types of data. The first multimodal input may comprise, e.g. a text input to receive a sequence of text or audio data representing values of an audio waveform, e.g. instantaneous amplitude data or time-frequency domain data; or non-image sensor data representing an environment with which an agent controlled by the multimodal machine learning model interacts. The second multimodal input may receive an image or video. The multimodal machine learning model may be configured to jointly process encoded versions of the first and second multimodal inputs.

The system and method described herein can therefore be used to perform a multimodal task. For example, some tasks that can be performed include multimodal tasks that involve processing an input sequence comprising a combination of an image and natural or computer language to generate an output sequence that performs the image processing task. The output sequence can be generated from the blocks obtained by partitioning the model neural network layer of generative neural network and the associated adapter subnetworks, which process both the image representation and token embeddings representing text or spoken words in a natural or computer language. The image processing task to be performed may be specified by the words in the natural or computer language.

An example involves generating an output that requires reasoning, e.g. spatio-temporal reasoning, to respond to a natural language query input, e.g. relating to a moving image (video). For example such a query may require predictive reasoning (“what will happen next”), counterfactual reasoning (“what would happen in a different circumstance”), explanatory reasoning (“why did something happen”), or causal reasoning generally. For example the image representation can be used to detect objects in the video frames and provide information relating to the detected objects in response to a query. The query may comprise, for example, a request for a prediction of a future event or state relating to one or more of the objects (e.g. “will objects X and Y collide?”), or a request for conditional or counterfactual information relating to one or more of the objects (e.g. “what event would [not] happen if object X is modified, moved or absent?”), or a request for analysis of the video frames to determine a property or characteristic of one or more of the objects (e.g. “how many objects of type Z are moving?”). The output may, for example, be in the form of a yes/no answer, or may define a probability distribution over a set of possible answers; or the response may define the location of an object. Such systems can be used to predict whether or not two objects will collide, or how this may be avoided. The output may be used e.g. to provide a warning and/or to control motion of one or more of the objects. Such a computer implemented method can be performed by a multimodal machine learning model such as a visual language model (VLM).

A computer-implemented method of performing an image processing task can involve obtaining an image and a string of words, i.e. text, in a natural or computer language, and processing pixels of the image using an (a trained) image encoder neural network, to generate a representation of the image. The text can be processed using a (trained) text encoder to generate a sequence of token embeddings representing the text. The representation of the image and the sequence of token embeddings can be processed using a visual language model to perform an image processing task defined by the text.

The text may be received, e.g., as a series of encoded characters, e.g. UTF-8 encoded characters; such “characters” can include Chinese and other similar characters, as well as logograms, syllabograms and the like. The multimodal machine learning model can include a text encoder that processes a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language.

The model output may comprise any form of output appropriate to the machine learning task performed by the multimodal machine learning model. For example the model output may comprises text in a natural or computer language that defines a result of the task, e.g. for tasks such as image captioning, visual question answering, or object detection or instance segmentation. Also or instead the model output may comprise data defining an image, video or audio object, e.g. in a generative task; or the model output may comprise non-textual action selection data for selecting an action to be performed by an agent controlled by the model. As another example the model output may also or instead define an intermediate step to be performed during the task, e.g. a call to a software API for a software tool that is used when performing the task; the multimodal input may then receive an output from the software tool that is used to generate a final model output that performs the task. A few particular examples of model output are given later.

Such a multimodal model can be trained using very large (but possibly noisy) datasets in which text is paired with an image and/or with one or more other types of data, e.g. audio data, or data relating to the operation of an agent acting in an environment to perform a variety of tasks. Such a model is can be trained, e.g., using self-supervised learning. The pairing can often be imperfect, and the training dataset can, but may not, include any actual examples of a particular task to be performed, but nonetheless an ability to perform a particular task can emerge. There are many examples of suitable, publicly available training datasets.

In general, performing an image processing task using a multimodal neural network such as a VLM, that includes an (a trained) image encoder neural network, can involve providing an image to the image encoder neural network to generate a representation of the image, in particular of features of the image. The representation of the image is then processed to perform the image processing task. In general techniques for processing image representations to perform a wide range of image processing tasks are well known. In general a video processing task can be performed by processing the representations of multiple images representing a sequence video frames.

Some example multimodal machine learning models with which the techniques described herein may be used include: Flamingo (Alayrac et al. arXiv: 2204.14198); ALIGN (Jia et al., arXiv: 2102.05918); PaLI (Chen et al. arXiv: 2209.06794) and PaLI-X (Chen et al. arXiv: 2305.18565); and Gemini (“Gemini: A Family of Highly Capable Multimodal Models, Gemini Team, Google”). These references also include indications of training datasets that may be used to train the respective models.

As used herein an image may be any still or moving image, i.e. the image may be part of a video, in 2D or 3D, and may be a monochrome, color or hyperspectral image, i.e. comprising monochrome or color pixels. As defined herein an “image” includes a point cloud e.g. from a LIDAR system, and a “pixel” includes a point of the point cloud. The image, during or after (pre-) training and/or fine tuning may, e.g. have been captured by a camera or other image sensor from the real world, and objects in the image or video may comprise physical objects, represented by the image or video.

A few examples of some machine learning tasks that can be performed by a model trained as described herein follow. The tasks described below may be tasks that require spatial awareness or other context from the image or video. For example, a prompt may ask “What is the object in the top left corner?”.

As one example the task may comprise an object or action detection task. A task-specific training data item may comprise an image or video containing one or more objects or actions, and a sequence of text. The sequence of text may describe or otherwise label the object(s) or action(s) and may include text giving bounding box coordinates for the object(s) or action(s). After training, when the model is used in inference, the model output (output sequence) may comprise or represent text that describes or otherwise labels detected object(s) or action(s) in the image input, and may include bounding-box coordinates for the detected object(s) or action(s), e.g. “10 20 90 100 cat 20 30 100 100 dog”.

As another example the task may comprise a classification task, e.g. an object or action classification task. A task-specific training data item may comprise an image or video item containing one or more objects or actions and a sequence of text. The sequence of text may describe or otherwise classify the object(s) or action(s). After training, when the model is used in inference, the model output (output sequence) may comprise data, e.g. text, that classifies the object(s) or action(s) in the image input into one of a plurality of classes.

As another example the task may comprise an image or video describing task, e.g. a captioning task (which, as used here, includes an audio description task to explain what is happening in a video). A task-specific training data item may comprise an image or video and a sequence of text describing the image or video. After training, when the model is used in inference, the model output may comprise data, e.g. text, describing the image or video. For example the model output may provide a caption or description or it may count objects in the image or video, or it may provide some other form of description.

As another example the task may comprise an image or video question-answering task. A task-specific training data item may comprise an image or video and a sequence of text that describes the image or video. After training, when the model is used in inference, the model output may comprise data, e.g. text, that answers a question about the second modality input specified in a prompt sequence of text, e.g. as described above. This data may be used, e.g., to answer questions about visual plots and charts or about sounds.

As another example the task may comprise a character or word recognition task, e.g. an OCR (optical character recognition) task. A task-specific training data item may comprise an image or video and a sequence of text that includes text that is depicted in the image or video, or that is represented as speech in the audio item. After training, when the model is used in inference, the model output may comprise text that represents characters or words in the second modality input, e.g. in a natural language.

As another example the task may comprise a still or moving image generation task; Google DeepMind Gemini is an example of a system that can generate an image output. As another example an image such as a plot or chart may be decoded from one or more (language) tokens generated by the system. A training data item for such a system may comprise an image or video and a sequence of text that describes the image or video. After training, when the model is used in inference, the model output may comprise data for an image or video, e.g. image data defining values for pixels of a still or moving image, and the sequence of text in the multimodal input to the model may describe or characterize the image or video to be generated.

As another example the task may comprise a computer language text generation task. A task-specific training data item may comprise an image or video and a sequence of text in a computer language for generating the image or video. After training, when the model is used in inference, the model output may comprise text in the or another computer language for generating or rendering an image or video, e.g. a web page, plot, or chart.

In another example of a computer language text generation task, a task-specific training data item may comprise an image or video and a sequence of text in a computer language for performing a task in relation to the image or video, e.g. a data processing task that involves analyzing the content of the image or video to provide a result of the analysis or, e.g., a search to search for information relating to the content of the image or video. The computer language in the model output may comprise computer language for invoking a function or calling one or more external APIs. Merely as one example, such an output may be formatted as a JSON object. As previously, the sequence of text in the multimodal input may define the task to be performed and the second modality input may comprise, e.g. an image or video in relation to which the task is to be performed, e.g. a task that involves manipulation of particular types of data that may benefit from access to an API such as mathematical data, date/time related data, scientific data, recent data that may post-date training of the model (that may be accessed by a search function or API), and so forth. After training, when the model is used in inference, the model output may comprise text in the or another computer language for performing a task, e.g. as described above, in relation to an image or video in the second modality input. The method may then include using the text in the computer language to perform the task.

Some further examples of multimodal processing tasks include open-vocabulary image classification (the output can classify an image input based on a text input comprising text descriptions of one or more classes in the image), open-vocabulary object detection (the output can detect one or more objects in the image input based on a text input comprising text descriptions of the one or more objects), image captioning (the output can comprise text that describes the image input), text-based image search (the output can identify from amongst multiple images in the image input one or more images that meet a text description of images to be retrieved, the text description being provided in a text input), image-based retrieval (the output can identify from amongst multiple images in the image input one or more images that match an further image in the image input), and so on. Where a system/neural network is able to perform multiple different such tasks, the multi-modal processing task to be performed can be defined by text in a text input to the system/neural network.

In general, where the model output comprises text this may be provided as speech representing the text.

In some implementations, the machine learning task comprises an agent control task in which the agent interacts with an environment to perform the agent control task. In these implementations the multimodal input includes an observation characterizing the environment. For example the multimodal input can include a sequence of text that defines the task to be performed by the agent and the image can represent an observation of the environment, e.g. captured by a camera or other imaging device from a real-world environment. A task-specific training data item may comprise a sequence of text representing one or more actions of the agent, and an image observation of the environment. After training, when the model is used in inference, the model output comprises an action selection output, e.g. including text, that is used to select one or more actions to be performed by the agent in the environment in response to the observation. As an illustration the model output (output sequence) may define an action as text such as “A: 132 114 128 5 25 156”, that can be converted into a control signal for a mechanical agent, such as a mechanical robot, e.g. “ΔT=[0.1, −0.2,0] ΔR=[10°, 25°, −7°]”. As another example the action selection output may also or instead define one or more low-level skills, e.g. from a vocabulary of previously learnt skills. As before, the sequence of text in the multimodal input to the model may describe the task to be performed, e.g. “What action should the robot take to [perform task]”.

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a mechanical robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some agent control implementations, the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The observations may be obtained from an observation capture subsystem, e.g. a monitoring system such as a video camera or sound capture system, to capture visual observations of the user performing the task. The actions may comprise instructions in the form of, e.g., text, image, video, or audio data such as speech, that guide the user in performing the task.

In some implementations, the multimodal input can include an observation characterizing an environment of an agent performing a task, e.g. a mechanical agent or software agent. The observation may characterize the environment at a particular time step and the model output may define one or more actions to be performed by the agent at the time step. For example each action may be expressed as a sequence of text, e.g. as one or more characters such as letters and numbers, that represents the action, or as text that defines a low-level “skill” from a set of skills; or the model output may, e.g., define parameters of a probability distribution from which an action is selected. Optionally the text received by a text input may include text describing the task to be performed. Optionally the text input may include a description of one or more actions performed at a preceding time step. Where the agent is a software agent the model output may comprise a text output for calling a software API at a time step, and the model input at a subsequent time step, e.g. the text input, may comprise a response from the software agent, e.g. from the API.

Some examples of multimodal machine learning models controlling an agent, and with which the techniques described herein may be used, are described in: PaLM-E (Driess et al. arXiv: 2303.03378); RT-1 (Brohan et al. arXiv: 2212.06817); and RT-2 (Brohan et al. arXiv: 2307.15818).

Such a multimodal machine learning model can have an audio input, or an agent action input to receive agent action data representing an action of an agent performing a task in an environment. Data received in this way may be jointly processed with data from a text input and from an image input to generate the model output.

Such a multimodal machine learning model has a multimodal input and can, in implementations, perform a range of different tasks. However in implementations not every task that the model performs requires a multimodal input, e.g. a task to generate an image from a text description of the image, or an image captioning task. In some implementations, after training, the text input can be used to specify a particular task that is to be performed by the multimodal machine learning model, e.g. by providing a “prompt” to the model describing the task to be performed or giving an example of the task as a prompt to the model. Such prompts may optionally be included in the training data.

The multimodal machine learning model is configured to process the multimodal input (input sequence) in accordance with the trainable parameters of the multimodal machine learning model, to generate a model output (output sequence) that defines a result of one or more machine learning tasks. A training system can include a training engine to train the multimodal machine learning model, i.e. to update values of the trainable parameters, to perform the machine learning task(s), using training data items stored in one or more training datasets.

In general each training data item comprises multimodal data for use in training the multimodal machine learning model, e.g. using a self-supervised training objective. As another example such a multimodal machine learning model can also or instead be trained using a reinforcement learning objective, e.g. when the model is used to control an agent to perform a task.

There are many different types of self-supervised objective function that may be used. As one example the model may be trained using a softmax cross entropy loss, e.g. using language model style teacher forcing with a softmax cross entropy loss. As another example the model may be trained with an autoregressive negative log likelihood (NLL) loss, such as

$$- {\sum }_{l = 1}^{L} log p ( {y}_{l} \vert {y}_{< l} , {x}_{\leq l} )$$

for a multimodal input comprising a sequence of text encoded as L tokens with the lth text token y, conditioned on preceding second modality inputs x_{≤l}, such as one or more images or videos, and conditioned on preceding text tokens y_{<1}. As another example the model may be trained with a masking loss, e.g. a loss that requires the model to predict masked-out data such as masked out text tokens. As another example the multimodal machine learning model can be trained using a self-supervised objective function that comprises a contrastive loss function (one that is dependent upon a positive example and one or more negative examples).

There are, similarly, many different types of reinforcement learning objective function that may be used.

Each training data item may comprise, e.g., an example sequence of text and an example of the second modality input, e.g. an example image or video; in general these are semantically related to one another (but not always, as the training dataset may be noisy). As an example, matched, text and image or video data and may be obtained from web pages, e.g. from images or videos and their corresponding alt-text (text from the HTML or XHTML alt attribute); or from web pages where images or video and text are interleaved with one another. One example of such a dataset is WebLI (Web Language Image, Chen et al. arXiv: 2305.18565v1). Training datasets for other types of second modality input can similarly be obtained from web pages. Such training datasets can be large, e.g. >10⁷, 10⁸ or 10⁹ items.

Also or instead, smaller but more specialized training datasets can be used, e.g. to fine tune a model for a particular task or tasks. A few examples for visual tasks are the Visual Genome dataset for Visual Question Answering (Krishna et al., arXiv: 1602.07332); Objects365 (Shao et al., “Objects365: A large-scale, high-quality dataset for object detection”, IEEE/CVF international conference on computer vision, pages 8430-8439); Open Images V4 (Kuznetsova et al., arXiv: 1811.00982); the SBU dataset (Ordonez et al. “Im2Text: Describing Images Using 1 Million Captioned Photographs”, NeurIPS 2011); the Conceptual Captions datasets, e.g. V1 (2 M images) or V2 (10 M images) (Sharma et al., “Conceptual Captions: A Cleaned, Hypernymed, Image Alt-text Dataset For Automatic Image Captioning”, ACL 2018); and Kinetics for video (Kay et al., arXiv: 1705.06950). An example task-specific training dataset for audio data is AudioSet (Gemmeke et al., “Audio set: An ontology and human-labeled dataset for audio events,” ICASSP, IEEE, 2017, pp. 776-780). An example task-specific training dataset for agent (robot) control is described in Ebert et al., arXiv: 2109.13396.

### Control Tasks

In some further applications the method, or a corresponding system, is used for natural language control of a task in a real-world environment. That is, the natural language request may relate to the task, e.g. it may comprise a request to perform the task, and the reply, i.e. the information provided by the method/system in the reply, may be used to control e.g. a mechanical system (which may be referred to as a mechanical agent), or a computer system for performing the task.

As one example, the natural language request may comprise a high level request, e.g. from a human, to perform a task, e.g., “How would you put the empty bottle in the bin?”, “Bring me a glass of water”, or “Can you put the vacuum cleaner in the cupboard?”. The or each natural language reply may define one or more steps of the task, which may then be interpreted by the mechanical system, more specifically a control system of the mechanical system, to perform the step of the task. For example such a control system may convert the natural language reply into a series of primitive actions to be performed by the mechanical system to perform the step of the task.

Thus in some implementations the method, or a corresponding system, is used for controlling a mechanical system, or mechanical agent, acting in a real world environment to perform a task. The mechanical system may be, e.g. a robot or an autonomous or semi-autonomous vehicle. Determining, the input sequence may comprise obtaining, from one or more sensors, one or more observations of the real world environment, and processing the one or more observations to generate a natural language representation of the one or more observations. Merely as one example, an image captioning model (which here includes a video captioning model) can be used to process an image in this way; other models can be trained to perform a corresponding task for other types of sensor/sensed data than images. The natural language representation of the one or more observations can be used to provide one or more natural language statements for the input sequence. The natural language request may relates to an action to be performed by the mechanical system. The natural language reply (or the natural language output statement) may be used to control the mechanical system in the real world environment. For example the reply may define an action to control movement or navigation of the robot or vehicle in the real-world environment. Such an action may be a high level action or “skill” that may be translated into one or more lower level or “primitive” actions, e.g. by a trained neural network.

In some implementations the mechanical system has a control system to control actions of the mechanical system. Receiving the natural language request may comprise receiving a control signal from the control system and generating the natural language request from the control signal. For example there may be a dialogue between the agent comprising the generative neural network and the mechanical system and/or a human (e.g. if a control system of the mechanical system has a human user interface). Rules or preferences (preference scores) may impose constraints on actions to be taken e.g. for safety or other reasons.

The mechanical system, hereafter also termed the mechanical agent, may include one or more sensors that capture observations of the environment, e.g., at specified time intervals, as the mechanical agent navigates through the environment or attempts to perform a task in the environment. For example, the observations may include, e.g., one or more of: images, object position data, and sensor data to capture observations as the mechanical agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the mechanical agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the mechanical agent or data from sensors that are located separately from the mechanical agent in the environment.

The mechanical agent may be associated with a control system that generates control signals for controlling the mechanical agent using the observations generated by the sensors. In particular, the control system may generate control signals that cause the mechanical agent to follow a planned trajectory through the environment by first determining an appropriate action for the mechanical agent to perform, e.g., as part of performing a specified task, e.g., navigating to a particular location, identifying a particular object, moving a particular object to a given location, manipulating a particular object in some way, and so on, and then generating control signals that cause the mechanical agent to perform the action.

Such a control system can be deployed on-board the mechanical agent or can be deployed remotely from the mechanical agent and can transmit the control signals to the mechanical agent over a data communication network. The control signals can be control inputs to control the mechanical agent. For example, when the mechanical agent is a robot the control signals can be, e.g., torques for the joints of the robot or higher-level control commands. As another example, when the mechanical agent is an autonomous or semi-autonomous land, air, sea vehicle, the control signals can include actions to control navigation, e.g., steering, and movement of the vehicle, e.g., braking and/or acceleration of the vehicle. For example, the control signals can be, e.g., torques to the control surface or other control elements, e.g., steering control elements of the vehicle, or higher-level control commands. In other words, the control signals can include, for example, position, velocity, or force/torque/acceleration data for one or more joints of a robot or of parts of another mechanical agent (system).

In these examples, like the control system, software to implement a method as described herein (“system software”) can be deployed on-board the mechanical agent or can be deployed remotely from the mechanical agent.

In these implementations, the system software may be used to provide an additional layer of control on top of the control system and the system software or another component can determine the request based on information received by the control system. For example, the request may be determined by receiving a control signal from the mechanical agent control system, and then determining one or more natural language requests, e.g., relating to the mechanical agent in the environment, from the control signal. The reply may be used to control the mechanical system.

In some implementations, the mechanical agent control system is an autonomous or semi-autonomous control system, e.g., that autonomously or semi-autonomously controls navigation or other actions of the mechanical agent, e.g. vehicle. Also or instead the mechanical agent control system may have an interface to receive control commands, e.g., from a human operator.

In these applications the described system software may be used to provide an additional layer of control, e.g., for safety purposes. For example the described system software may be used to inhibit control of the mechanical agent in a way that could be dangerous or contrary to one or more rules or preferences (as defined by preference scores). Rules relating to control of the mechanical agent may be entered explicitly, e.g., as natural language statements. As one example, such rules or preferences (preference scores) may include rules/preferences relating to permitted movement of a vehicle, such as traffic rules, or of a robot, e.g. related to permitted (or forbidden) or preferable rules relating to safe movements or types of task. Such rules/preferences may include rules/preferences relating to decisions to be made to ensure safe behavior of the mechanical agent, e.g., to inhibit damage to the mechanical agent or to a human.

Thus, each request may relate to an action to be performed by the mechanical agent, e.g., an action that is under consideration by the control system. For example, a request can define an action to be performed by the mechanical agent, e.g., in the form of a question such as “Do I turn left?” or “Is it safe for the agent to turn left?”. As another example, a request can ask what action is to be performed by the mechanical agent, e.g., “Which way should the mechanical agent turn?”. In the case of a robot, the request can relate to a sub-task of a series of sub-tasks that are to be performed to perform a task, e.g., “What do I do next?” or “Do I pick up object X?”. The sub-tasks may themselves comprise a series of primitive actions for moving parts of the robot, e.g., to open grippers.

In general, the request can include a natural language description that defines information the reply from the system software is to provide. That is, the request can explicitly or implicitly determine what is required from the reply.

The reply to the request may be used to control the mechanical agent in the real world environment. More specifically, the reply may be used to control an action to be performed by the mechanical agent. As one example, the reply may inhibit an action that would otherwise be performed, i.e., the response may determine whether or not an action defined by the request is performed. As another example the reply may define an action to be performed, e.g., where the request implicitly or explicitly requests an action to be determined.

In such implementations, obtaining the input sequence can include obtaining one or more observations of the real world environment which, because the environment includes the mechanical agent, potentially includes one or more observations of the mechanical agent. The observations may be obtained from one or more sensors that may, but need not be, sensors of the mechanical agent. As described above, the observations may include still or moving images, and/or other sensor data from one or more sensors sensing a state of the environment or mechanical agent. As used herein “images” includes LIDAR point clouds.

In some agent control implementations, the agent may be a human agent and the environment may be a real-world environment. For example the agent can be a human user of a digital assistant such as a smart speaker, smart display, or some other device that is used to instruct the user to perform actions. The input sequence may define a task, which may be any real-world task that the user wishes to perform. The input sequence may comprise observations that may be obtained from an observation capture subsystem, e.g. a monitoring system such as a video camera or sound capture system, to capture visual observations of the user performing the task. The output sequence may represent instructions in the form of, e.g., text, image, video, or audio data such as speech, that guide the user in performing the task.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Certain concepts underlying the present disclosure are summarized by the following clauses:

1. A computer-implemented method of determining an estimate of uncertainty associated with a plurality of candidate output token sequences generated using a trained generative neural network, the method comprising:
obtaining an input token sequence;
using the generative neural network to process the input token sequence to generate the plurality of candidate output token sequences for the input token sequence, the processing comprising, for each candidate output token sequence, using the generative neural network to generate a respective embedding vector associated with the candidate output token sequence;
processing each embedding vector, using an embedding model, to generate a respective lower-dimensional embedding of the embedding vector;
determining a respective distance value for each pair of lower-dimensional embeddings in the plurality of lower-dimensional embeddings; and
determining the estimate of uncertainty associated with the plurality of candidate output token sequences based on the plurality of distance values.
   2. The method of clause 1, wherein determining the estimate of uncertainty comprises determining, as the estimate of uncertainty, an estimate of the volume spanned by the lower-dimensional embeddings in an associated embedding space based on the plurality of distance values.
   3. The method of clause 2, wherein determining the estimate of the volume spanned by the lower-dimensional embeddings comprises:
generating, from the plurality of distance values, a matrix input for a determinant function;
determining an output of the determinant function; and
determining the estimate of the volume spanned by the lower-dimensional embeddings from the output of the determinant function.
   4. The method of clause 3, wherein the estimate of the volume spanned by the lower-dimensional embeddings is determined as the logarithm of the determinant of (L(L+1)⁻¹, where L denotes a covariance matrix of the distance values for the embeddings.
   5. The method of clause 1, wherein determining the estimate of uncertainty comprises:
obtaining clustering data by assigning, based on the determined distance values, each lower-dimensional embedding to one of a plurality of clusters; and
determining the estimate of uncertainty based on the clustering data.
   6. The method of clause 5, wherein determining the estimate of uncertainty based on the clustering data comprises determining the estimate of uncertainty based on the number of lower-dimensional embeddings assigned to each cluster.
   7. The method of clause 5 or 6, wherein obtaining clustering data comprises:
determining, based on the determined distance values, the number of clusters in the plurality of lower-dimensional embeddings;
selecting, for each cluster, one of the lower-dimensional embeddings as respective cluster center for the cluster based on the determined distance values; and
assigning, for each of the remaining lower-dimensional embeddings, the remaining lower-dimensional embedding to one of the clusters based on the determined distance values between the remaining lower-dimensional embedding and the cluster centers.
   8. The method of clause 7, wherein the number of clusters in the plurality of lower-dimensional embeddings is determined based on the trace of a matrix formed based on the distance values.
   9. The method of clause 8, wherein the number of clusters in the plurality of lower-dimensional embeddings is determined based on the trace of a matrix (L(L+I)⁻¹), where L denotes a covariance matrix of the distance values for the embeddings.
   10. The method of any one of clauses 7 to 9, wherein selecting, for each cluster, one of the lower-dimensional embeddings as respective cluster center for the cluster based on the determined distance values comprises iteratively selecting one of the lower-dimensional embeddings as respective cluster center, each iteration comprising:
determining, for each remaining lower-dimensional embedding, a determinant value of a matrix formed based on the distance values for the remaining lower-dimensional embedding and the cluster centers selected in the previous iterations; and
selecting, as cluster centers for the current iteration, one of the remaining lower-dimensional embeddings based on the determined determinant values.
   11. The method of any preceding clause further comprising outputting of the estimate of uncertainty.
   12. The method of any preceding clause further comprising:
selecting one of the candidate output token sequences based on the determined distance values; and
outputting, as the response to the input token sequence, the selected candidate output token sequence.
   13. The method of clause 12, wherein selecting one of the candidate output token sequences based on the determined distance values comprises selecting the candidate output token sequence that is associated with the largest eigenvector of a matrix formed based on the distance values.
   14. The method of clause 12, when dependent on clause 5, wherein selecting one of the candidate output token sequences based on the determined distance values comprises:
determining, from the plurality of clusters, the cluster that comprises the largest number of lower-dimensional embeddings; and
selecting one of the candidate output token sequences associated with the cluster that comprises the largest number of lower-dimensional embeddings.
   15. The method of any preceding clause further comprising:
determining whether the estimate of uncertainty exceeds a threshold criterion; and in response to determining that the estimate of uncertainty exceeds a threshold criterion, refraining from outputting one of the candidate output token sequences as the response to the input token sequence.
   16. The method of any preceding clause further comprising:
determining whether the estimate of uncertainty exceeds a threshold criterion;
in response to determining that the estimate of uncertainty exceeds a threshold criterion, processing the input token sequence, using a trained second generative neural network, to generate a further candidate output token sequence; and
outputting, as the response to the input token sequence, the further candidate output token sequence,
wherein the second generative neural network has a larger number of learnable parameters than the first-mentioned generative neural network.
   17. The method of any preceding clause further comprising:
determining whether the estimate of uncertainty exceeds a threshold criterion;
in response to determining that the estimate of uncertainty exceeds a threshold criterion, obtaining a further input token sequence;
using the generative neural network to process the first-mentioned input token sequence and the further input sequence to generate a further candidate output token sequence; and
outputting, as the response to the input token sequence, the further candidate output token sequence.
   18. The method of any preceding clause, wherein the generative neural network is in communication with at least one agent, and wherein the method further comprises:
determining whether the estimate of uncertainty exceeds a threshold criterion;
in response to determining that the estimate of uncertainty exceeds a threshold criterion, transmitting a query to the agent;
receiving, from the agent, a response data item for the transmitted query;
using the generative neural network to process the input token sequence and the response data item to generate a further candidate output token sequence; and
outputting, as the response to the input token sequence, the further candidate output token sequence.
   19. The method of any preceding clause, wherein for each candidate output token sequence, the respective embedding vector associated with the candidate output token sequence is generated by:
generating, for each position in the candidate output token sequence, a respective score vector based on the input token sequence and based on any previously selected tokens in the output token sequence; and
generating the respective embedding vector based on the generated score vectors.
   20. The method of clause 19, wherein the respective embedding vector is generated by averaging the respective score vectors across the positions in the candidate output token sequence.
   21. The method of any preceding clause, wherein the generative neural network comprises a plurality of hidden layers, and the embedding vectors are generated based on scores generated by one of the hidden layers, preferably the last hidden layer.
   22. The method of any preceding clause, wherein the embedding model is a trained neural network.
   23. The method of any preceding clause, wherein the embedding model is a trained neural network consisting of an input layer, one hidden layer and an output layer.
   24. The method of any preceding clause, wherein the input token sequence comprises one or more text tokens.
   25. The method of any preceding clause, wherein the candidate output token sequence comprises one or more text tokens.
   26. The method of any preceding clause, wherein the input token sequence comprises one or more tokens representing image data or audio data.
   27. The method of any preceding clause, wherein the candidate output token sequence comprises one or more tokens representing image data or audio data.
   28. The method of any preceding clause, wherein the generative neural network is a transformer-based generative neural network.
   29. The method of any preceding clause, wherein the embedding model has been trained according to the method of any one of clauses 34 to 38.
   30. The method of any preceding clause, wherein the distance values are determined using a trained distance model configured to generate a distance value for a pair of input low-dimensional embeddings.
   31. The method of any preceding clause, wherein using the generative neural network to process the input token sequence comprises using a plurality of instances of the generative neural network to process the input token sequence to generate the plurality of candidate output token sequences and the associated embedding vectors in parallel.
   32. The method of clause 31, wherein the method is performed by a parallel or distributed processing system comprising a plurality of processing units each implementing a respective instance of the generative neural network, the method further comprising:
distributing the input token sequence to each of the plurality of processing units; and
using the plurality of processing units in parallel, to process the input token sequence to generate the plurality of candidate output token sequences and the associated embedding vectors in parallel.
   33. The method of any preceding clause, wherein the generative neural network is implemented on a parallel or distributed processing system comprising a plurality of processing units and is configured to process a batch of input tokens in parallel, and wherein using the generative neural network to process the input token sequence comprises:
generating a batch of input tokens comprising one repeated copy of part or all of the input token sequence per candidate output token sequence; and
processing the batch of input tokens in parallel, using the plurality of processing units, to generate the plurality of candidate output token sequences and the associated embedding vectors, comprising processing the batch of input tokens using the generative neural network to generate, in parallel, an output token for each candidate output token sequence.
   34. A computer-implemented method of training an embedding model to generate a lower-dimensional embedding from an input comprising an embedding vector, the method comprising:
obtaining a dataset of training examples, each training example comprising i) a plurality of training embedding vectors, each embedding vector associated with a corresponding training output token sequence, and ii), for each training embedding vector, a label indicating one of a plurality of clusters, wherein the training output token sequences associated with the same training example have been generated by a generative neural network for the same training input token sequence;
processing each training embedding vector, using the embedding model, to generate a respective lower-dimensional embedding;
determining a respective distance value for each pair of lower-dimensional embeddings in the plurality of lower-dimensional embeddings associated with the same training example; and
in each of a plurality of training steps:
sampling, for each cluster in the plurality of clusters associated with the same training example, an associated lower-dimensional embedding from the plurality of lower-dimensional embeddings;
evaluating a loss function based on the distance values associated with the sampled associated lower-dimensional embeddings; and
adjusting trainable parameters of the embedding model based on the evaluated loss function.
   35. The method of clause 34, wherein the loss function is a contrastive loss function comprising a first term that depends on the distance values associated with the sampled lower-dimensional embeddings, and a second term that depends on the distance values associated with the sampled lower-dimensional embeddings and on the distance values associated with the remaining lower-dimensional embeddings, wherein the first term encourages larger distance values for the sampled lower-dimensional embeddings, and the second term encourages smaller distance values for the sampled remaining lower-dimensional embeddings and the remaining lower-dimensional embeddings.
   36. The method of clause 35, wherein the loss function is given by (log det(L_{Y})-log det(L+I) where ‘log’ denotes the logarithm, ‘det’ denotes the determinant, ‘I’ denotes the identity matrix, ‘L’ denotes a covariance matrix of distance values for the sampled lower-dimensional embeddings and for the remaining lower-dimensional embeddings, and ‘L_{Y}’ denotes a covariance matrix of distance values for the sampled lower-dimensional embeddings.
   37. The method of any one of clauses 34 to 36 further comprising an initial step of generating, for each training embedding vector, the respective label indicating one of a plurality of clusters by:
processing the corresponding training output token sequences, using a further generative neural network, to perform pairwise bi-directional entailment to identify training output token sequences that are semantically consistent, and
generating, for each training embedding vector, the respective label indicating one of a plurality of clusters so that training output token sequences that are semantically consistent are associated with the same cluster.
   38. The method of any one of clauses 34 to 37, wherein the distance values are determined using a distance model configured to generate a distance value for a pair of input low-dimensional embeddings, the distance model having at least one learnable parameter, and the wherein the distance model is jointly trained with the embedding model.
   39. A system comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1-38.
   40. One or more non-transitory computer storage media storing instructions that when executed by one or more computers cause the one or more computers to perform the operations of the respective method of any one of clauses 1-38.

What is claimed is:

1. A computer-implemented method of determining an estimate of uncertainty associated with a plurality of candidate output token sequences generated using a trained generative neural network, the method comprising:
obtaining an input token sequence;
using the generative neural network to process the input token sequence to generate the plurality of candidate output token sequences for the input token sequence, the processing comprising, for each candidate output token sequence, using the generative neural network to generate a respective embedding vector associated with the candidate output token sequence;
processing each embedding vector, using an embedding model, to generate a respective lower-dimensional embedding of the embedding vector;
determining a respective distance value for each pair of lower-dimensional embeddings in the plurality of lower-dimensional embeddings; and
determining the estimate of uncertainty associated with the plurality of candidate output token sequences based on the plurality of distance values.

2. The method of claim 1, wherein determining the estimate of uncertainty comprises determining, as the estimate of uncertainty, an estimate of the volume spanned by the lower-dimensional embeddings in an associated embedding space based on the plurality of distance values.

3. The method of claim 2, wherein determining the estimate of the volume spanned by the lower-dimensional embeddings comprises:
generating, from the plurality of distance values, a matrix input for a determinant function;
determining an output of the determinant function; and
determining the estimate of the volume spanned by the lower-dimensional embeddings from the output of the determinant function.

4. The method of claim 1, wherein determining the estimate of uncertainty comprises:
obtaining clustering data by assigning, based on the determined distance values, each lower-dimensional embedding to one of a plurality of clusters; and
determining the estimate of uncertainty based on the clustering data.

5. The method of claim 4, wherein determining the estimate of uncertainty based on the clustering data comprises determining the estimate of uncertainty based on the number of lower-dimensional embeddings assigned to each cluster.

6. The method of claim 4, wherein obtaining clustering data comprises:
determining, based on the determined distance values, the number of clusters in the plurality of lower-dimensional embeddings;
selecting, for each cluster, one of the lower-dimensional embeddings as respective cluster center for the cluster based on the determined distance values; and
assigning, for each of the remaining lower-dimensional embeddings, the remaining lower-dimensional embedding to one of the clusters based on the determined distance values between the remaining lower-dimensional embedding and the cluster centers.

7. The method of claim 6, wherein the number of clusters in the plurality of lower-dimensional embeddings is determined based on the trace of a matrix formed based on the distance values.

8. The method of claim 6, wherein selecting, for each cluster, one of the lower-dimensional embeddings as respective cluster center for the cluster based on the determined distance values comprises iteratively selecting one of the lower-dimensional embeddings as respective cluster center, each iteration comprising:
determining, for each remaining lower-dimensional embedding, a determinant value of a matrix formed based on the distance values for the remaining lower-dimensional embedding and the cluster centers selected in the previous iterations; and
selecting, as cluster centers for the current iteration, one of the remaining lower-dimensional embeddings based on the determined determinant values.

9. The method of claim 1 further comprising:
selecting one of the candidate output token sequences based on the determined distance values; and
outputting, as the response to the input token sequence, the selected candidate output token sequence.

10. The method of claim 9, wherein selecting one of the candidate output token sequences based on the determined distance values comprises selecting the candidate output token sequence that is associated with the largest eigenvector of a matrix formed based on the distance values.

11. The method of claim 9, wherein selecting one of the candidate output token sequences based on the determined distance values comprises:
determining, from the plurality of clusters, the cluster that comprises the largest number of lower-dimensional embeddings; and
selecting one of the candidate output token sequences associated with the cluster that comprises the largest number of lower-dimensional embeddings.

12. The method of claim 1 further comprising:
determining whether the estimate of uncertainty exceeds a threshold criterion; and
in response to determining that the estimate of uncertainty exceeds a threshold criterion, refraining from outputting one of the candidate output token sequences as the response to the input token sequence.

13. The method of claim 1 further comprising:
determining whether the estimate of uncertainty exceeds a threshold criterion;
in response to determining that the estimate of uncertainty exceeds a threshold criterion, processing the input token sequence, using a trained second generative neural network, to generate a further candidate output token sequence; and
outputting, as the response to the input token sequence, the further candidate output token sequence,
wherein the second generative neural network has a larger number of learnable parameters than the first-mentioned generative neural network.

14. The method of claim 1, wherein for each candidate output token sequence, the respective embedding vector associated with the candidate output token sequence is generated by:
generating, for each position in the candidate output token sequence, a respective score vector based on the input token sequence and based on any previously selected tokens in the output token sequence; and
generating the respective embedding vector based on the generated score vectors.

15. The method of claim 1, wherein the generative neural network comprises a plurality of hidden layers, and the embedding vectors are generated based on scores generated by one of the hidden layers.

16. The method of claim 1, wherein using the generative neural network to process the input token sequence comprises using a plurality of instances of the generative neural network to process the input token sequence to generate the plurality of candidate output token sequences and the associated embedding vectors in parallel.

17. A system comprising:
one or more computers; and
one or more storage devices communicatively coupled to the one or more computers, wherein the one or more storage devices store instructions that, when executed by the one or more computers, cause the one or more computers to perform the operations for determining an estimate of uncertainty associated with a plurality of candidate output token sequences generated using a trained generative neural network, the operations comprising:
obtaining an input token sequence;
using the generative neural network to process the input token sequence to generate the plurality of candidate output token sequences for the input token sequence, the processing comprising, for each candidate output token sequence, using the generative neural network to generate a respective embedding vector associated with the candidate output token sequence;
processing each embedding vector, using an embedding model, to generate a respective lower-dimensional embedding of the embedding vector;
determining a respective distance value for each pair of lower-dimensional embeddings in the plurality of lower-dimensional embeddings; and
determining the estimate of uncertainty associated with the plurality of candidate output token sequences based on the plurality of distance values.

18. One or more non-transitory computer storage media storing instructions that when executed by one or more computers cause the one or more computers to perform the operations for determining an estimate of uncertainty associated with a plurality of candidate output token sequences generated using a trained generative neural network, the operations comprising:
obtaining an input token sequence;
using the generative neural network to process the input token sequence to generate the plurality of candidate output token sequences for the input token sequence, the processing comprising, for each candidate output token sequence, using the generative neural network to generate a respective embedding vector associated with the candidate output token sequence;
processing each embedding vector, using an embedding model, to generate a respective lower-dimensional embedding of the embedding vector;
determining a respective distance value for each pair of lower-dimensional embeddings in the plurality of lower-dimensional embeddings; and
determining the estimate of uncertainty associated with the plurality of candidate output token sequences based on the plurality of distance values.

19. The non-transitory computer storage media of claim 18, wherein determining the estimate of uncertainty comprises determining, as the estimate of uncertainty, an estimate of the volume spanned by the lower-dimensional embeddings in an associated embedding space based on the plurality of distance values.

20. The non-transitory computer storage media of claim 19, wherein determining the estimate of the volume spanned by the lower-dimensional embeddings comprises:
generating, from the plurality of distance values, a matrix input for a determinant function;
determining an output of the determinant function; and
determining the estimate of the volume spanned by the lower-dimensional embeddings from the output of the determinant function.
